(19) United States
(12) Patent Application Publication
(10) Pub. No.: US 2011/0103485 A1
(43) Pub. Date: May 5, 2011

(54) Image Processing Apparatus and Method

(76) Inventors: Kazushi Sato, Kanagawa (JP); Yoichi Yagasaki, Tokyo (JP)

(21) Appl. No.: 13/000,529

(22) PCT Filed: Jul. 1, 2009
(86) PCT No.: PCT/JP2009/062027

§ 371 Date: Dec. 21, 2010

(30) Foreign Application Priority Data
Jul. 1, 2008 (JP) 2008-172270

(51) Int. Cl. H04N 11/02

(52) U.S. Cl. 375/240.16; 375/E07.104; 375/E07.123

(57) ABSTRACT

The present invention relates to image processing apparatus and method which make it possible to prevent a decrease in compression efficiency without increasing computational complexity.

An intra-TP motion prediction/compensation unit 75 performs motion prediction within a predetermined search range by taking predicted motion vector information generated by an intra-predicted motion vector generating unit 76 as the center of search, on the basis of an image to be intra-predicted from a screen rearrangement buffer 62, and reference images from a frame memory 72. An inter-TP motion prediction/compensation unit 78 performs motion prediction within a predetermined search range by taking predicted motion vector information generated by an inter-predicted motion vector generating unit 79 as the center of search, on the basis of an image to be inter-encoded from the screen rearrangement buffer 62, and reference images from the frame memory 72. The present invention can be applied to, for example, an image encoding apparatus that performs encoding in H.264/AVC format.

### TECHNICAL FIELD

The present invention relates to image processing apparatus and method, and more specifically, image processing apparatus and method which prevent a decrease in compression efficiency without increasing computational complexity.

### BACKGROUND ART

In recent years, there has been a proliferation of techniques with which images are compressed and encoded in formats such as MPEG(Moving Picture Experts Group)2 or H.264 and MPEG-4 Part10 (Advanced Video Coding) (hereinafter, denoted as H.264/AVC), transmitted in a packetized manner, and decoded at the receiving side. This allows users to view high quality moving images.

Incidentally, in MPEG2 format, a motion prediction/compensation process with ½ pixel precision is performed by a linear interpolation process. In H.264/AVC format, a prediction/compensation process with ¼ pixel precision using a 6-tap FIR (Finite Impulse Response Filter) filter is performed.

Also, in MPEG2 format, in the case of the frame motion compensation mode, a motion prediction/compensation process is performed in 16×16 pixel units, and in the case of the field motion compensation mode, a motion prediction/compensation process is performed in 16×8 pixel units for each of the first field and the second field.

In contrast, in H.264/AVC format, motion prediction/compensation can be performed while making the block size variable. That is, in H.264/AVC format, it is possible to divide a single macroblock made up of 16×16 pixels into one of 16×16, 16×8, 8×16, and 8×8 partitions, each having independent motion vector information. Also, as for the 8×8 partition, it is possible to divide the partition into one of 8×8, 8×4, 4×8, and 4×4 sub-partitions, each having independent motion vector information.

However, in H.264/AVC format, performing the above-described ¼-pixel precision, variable-block motion prediction/compensation process results in generation of an enormous amount of motion vector information, and encoding this as it is causes a decrease in encoding efficiency.

Accordingly, there has been proposed a method which finds, from a decoded image, a region of an image having high correlation with a decoded image in a template region, which is adjacent to the region of an image to be encoded in a predetermined positional relationship and is a part of the decoded image, and performs prediction on the basis of the found region and the predetermined positional relationship (see PTL 1).

Since this method uses a decoded image for matching, by setting a search range in advance, it is possible to perform the same processing in the encoding apparatus and in the decoding apparatus. That is, by performing the prediction/compensation process as described above also in the decoding apparatus, motion vector information does not need to be included in the image compression information from the encoding apparatus, thereby making it possible to prevent a decrease in encoding efficiency.

### CITATION LIST

### Patent Literature

PTL 1: Japanese Unexamined Patent Application Publication No. 2007-43651

### SUMMARY OF INVENTION

### Technical Problem

As described above, the technique according to PTL 1 requires a prediction/compensation process not only in the encoding apparatus but also in the decoding apparatus. At this time, to ensure good encoding efficiency, a sufficiently large search range is required. However, an increase in search range causes an increase in computational complexity, not only in the encoding apparatus but also in the decoding apparatus.

The present invention has been made in view of the above circumstances, and aims to prevent a decrease in compression efficiency without increasing computational complexity.

### Solution to Problem

An image processing apparatus according to an aspect of the present invention includes a predicted motion vector generating unit that generates a predicted value of a motion vector of a first current block in a frame, and a first motion prediction/compensation unit that calculates a motion vector of the first current block by using a first template, within a predetermined search range around the predicted value of the motion vector generated by the predicted motion vector generating unit, the first template being adjacent to the first current block in a predetermined positional relationship and generated from a decoded image.

The predicted motion vector generating unit can generate the predicted value of the motion vector of the first current block by using information on motion vectors for adjacent blocks, the adjacent blocks being previously encoded blocks and blocks adjacent to the first current block.

The predicted motion vector generating unit can generate the predicted value of the motion vector of the first current block by using the information on the motion vectors calculated for the adjacent blocks within the frame.

If the information on the motion vectors calculated for the adjacent blocks within the frame does not exist, the predicted motion vector generating unit can generate the predicted value of the motion vector of the first current block by setting the information on the motion vectors for the adjacent blocks to 0.

If the information on the motion vectors calculated for the adjacent blocks within the frame does not exist, the predicted motion vector generating unit can generate the predicted value of the motion vector of the first current block by using information on motion vectors calculated for the adjacent blocks by referencing a previously encoded frame different from the frame.

If information on the previously encoded frame is larger than a predetermined value, the predicted motion vector generating unit can prohibit use of the information on the motion vectors calculated for the adjacent blocks by referencing the previously encoded frame.

If the information on the motion vectors calculated for the adjacent blocks within the frame does not exist, the first motion prediction/compensation unit can calculate motion vectors of the adjacent blocks by using a second template, the second template being adjacent to each of the adjacent blocks in a predetermined positional relationship and generated from the decoded image, and the predicted motion vector generating unit can generate the predicted value of the motion vector of the first current block by using the information on the motion vectors for the adjacent blocks calculated by the first motion prediction/compensation unit.

The image processing apparatus can further include an intra-prediction unit that predicts pixel values of a second current block in the frame from the decoded image within the frame.

The predicted motion vector generating unit can generate the predicted value of the motion vector of the first current block by using the information on the motion vectors calculated for the adjacent blocks by referencing a previously encoded frame different from the frame.

If the information on the motion vectors calculated for the adjacent blocks by referencing the previously encoded frame does not exist, the predicted motion vector generating unit can generate the predicted value of the motion vector of the first current block by setting the information on the motion vectors for the adjacent blocks to 0.

If the information on the motion vectors calculated for the adjacent blocks by referencing the previously encoded frame does not exist, the predicted motion vector generating unit can generate the predicted value of the motion vector of the first current block by using information on motion vectors calculated for the adjacent blocks within the frame.

If the information on the motion vectors calculated for the adjacent blocks by referencing the previously encoded frame does not exist, the first motion prediction/compensation unit can calculate motion vectors of the adjacent blocks by using a second template, the second template being adjacent to each of the adjacent blocks in a predetermined positional relationship and generated from the decoded image, and the predicted motion vector generating unit can generate the predicted value of the motion vector of the first current block by using the information on the motion vectors for the adjacent blocks calculated by the first motion prediction/compensation unit.

The image processing apparatus can further include a decoding unit that decodes encoded information on a motion vector, and a second motion prediction/compensation unit that generates a predicted image by using a motion vector of a second current block in the frame decoded by the decoding unit.

The predicted motion vector generating unit can generate the predicted value of the motion vector of the first current block by using information on motion vectors for adjacent blocks, the adjacent blocks being previously encoded blocks and blocks adjacent to the first current block, information on motion vectors for a co-located block and blocks adjacent to the co-located block, the co-located block being a block in a previously encoded frame different from the frame and a block co-located with the first current block, or information on motion vectors for the co-located block and the adjacent blocks.

If the information on the motion vectors calculated for the adjacent blocks by referencing the previously encoded frame does not exist, the predicted motion vector generating unit can generate the predicted value of the motion vector of the first current block by setting the information on the motion vectors for the adjacent blocks to 0.

If the information on the motion vectors calculated for the adjacent blocks by referencing the previously encoded frame does not exist, the predicted motion vector generating unit can generate the predicted value of the motion vector of the first current block by using information on motion vectors calculated for the adjacent blocks within the frame.

If the information on the motion vectors calculated for the adjacent blocks by referencing the previously encoded frame does not exist, the first motion prediction/compensation unit can calculate motion vectors of the adjacent blocks by using a second template, the second template being adjacent to each of the adjacent blocks in a predetermined positional relationship and generated from the decoded image, and the predicted motion vector generating unit can generate the predicted value of the motion vector of the first current block by using the information on the motion vectors for the adjacent blocks calculated by the first motion prediction/compensation unit.

The image processing apparatus can further include a decoding unit that decodes encoded information on a motion vector, and a second motion prediction/compensation unit that generates a predicted image by using a motion vector of a second current block in the frame decoded by the decoding unit.

An image processing method according to an aspect of the present invention includes the steps of an image processing apparatus generating a predicted value of a motion vector of a current block in a frame, and calculating a motion vector of the current block by using a template, within a predetermined search range around the generated predicted value of the motion vector, the template being adjacent to the current block in a predetermined positional relationship and generated from a decoded image.

According to an aspect of the present invention, a predicted value of a motion vector of a current block in a frame is generated, and a motion vector of the current block is calculated by using a template, within a predetermined search range around the generated predicted value of the motion vector, the template being adjacent to the current block in a predetermined positional relationship and generated from a decoded image.

### Advantageous Effects of Invention

As described above, according to an aspect of the present invention, images can be encoded or decoded. Also, according to an aspect of the present invention, a decrease in compression efficiency can be prevented without increasing computational complexity.

### BRIEF DESCRIPTION OF DRAWINGS

FIG. 1 is a block diagram showing the configuration of an embodiment of an image encoding apparatus to which the present invention is applied.

FIG. 2 is a diagram for explaining a variable-block-size motion prediction/compensation process.

FIG. 3 is a diagram for explaining a motion prediction/compensation process with ¼ pixel precision.

FIG. 4 is a flowchart for explaining an encoding process in which image code in FIG. 1 is an apparatus.

FIG. 5 is a flowchart for explaining a prediction process in step S21 in FIG. 4.

FIG. 6 is a diagram for explaining the order of processing in the case of intra-prediction mode of 16×16 pixels.

FIG. 7 is a diagram showing kinds of intra-prediction modes of 4×4 pixels for luminance signals.

FIG. 8 is a diagram showing kinds of intra-prediction modes of 4×4 pixels for luminance signals.

FIG. 9 is a diagram for explaining directions of intra-prediction of 4×4 pixels.

FIG. 10 is a diagram for explaining intra-prediction of 4×4 pixels.

FIG. 11 is a diagram for explaining encoding in intra-prediction mode of 4×4 pixels for luminance signals.

FIG. 12 is a diagram showing kinds of intra-prediction modes of 16×16 pixels for luminance signals.

FIG. 13 is a diagram showing kinds of intra-prediction modes of 16×16 pixels for luminance signals.

FIG. 14 is a diagram for explaining intra-prediction of 16×16 pixels.

FIG. 15 is a diagram showing kinds of intra-prediction modes for chrominance signals.

FIG. 16 is a flowchart for explaining an intra-prediction process in step S31 in FIG. 5.

FIG. 17 is a flowchart for explaining an inter-motion prediction process in step S32 in FIG. 5.

FIG. 18 is a diagram for explaining an example of a method of generating motion vector information.

FIG. 19 is a diagram for explaining another example of a method of generating motion vector information.

FIG. 20 is a flowchart for explaining an intra-template motion prediction process in step S33 in FIG. 5.

FIG. 21 is a diagram for explaining an intra-template matching format.

FIG. 22 is a flowchart for explaining an inter-template motion prediction process in step S35 in FIG. 5.

FIG. 23 is a diagram for explaining an inter-template matching format.

FIG. 24 is a block diagram showing the configuration of an embodiment of an image decoding apparatus to which the present invention is applied.

FIG. 25 is a flowchart for explaining a decoding process in the image decoding apparatus in FIG. 24.

FIG. 26 is a flowchart for explaining a prediction process in step S138 in FIG. 25.

FIG. 27 is a diagram for explaining intra-motion prediction.

### DESCRIPTION OF EMBODIMENTS

Hereinbelow, embodiments of the present invention will be described with reference to the drawings.

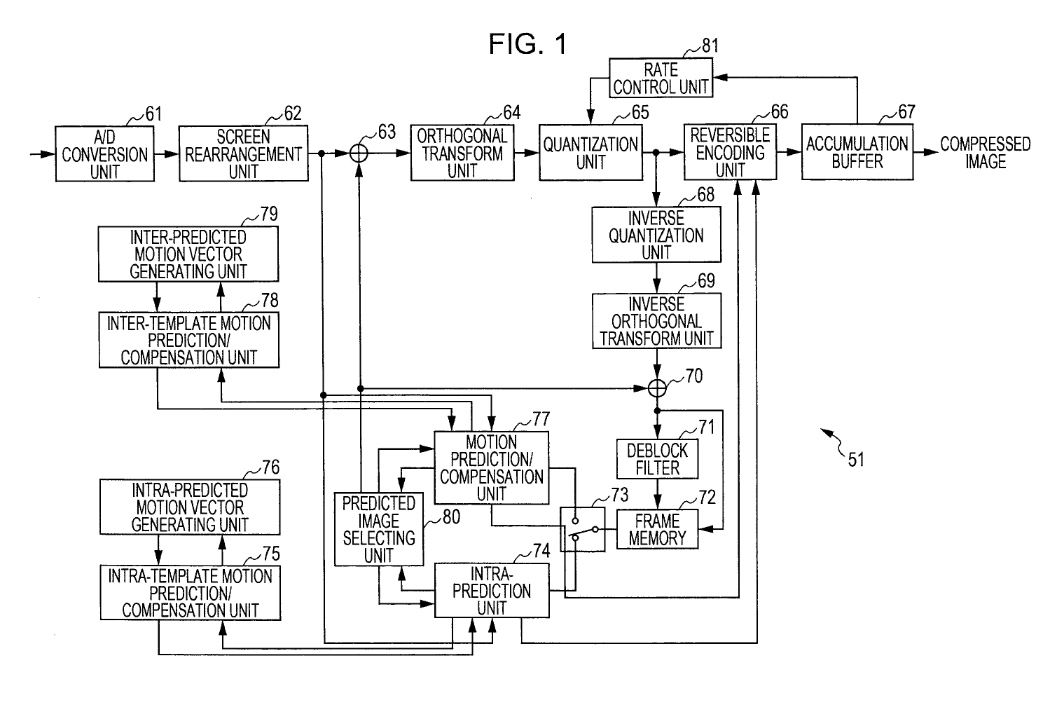

FIG. 1 shows the configuration of an embodiment of an image encoding apparatus according to the present invention. An image encoding apparatus 51 includes an A/D conversion unit 61, a screen rearrangement buffer 62, a computing unit 63, an orthogonal transform unit 64, a quantization unit 65, a reversible encoding unit 66, an accumulation buffer 67, an inverse quantization unit 68, an inverse orthogonal transform unit 69, a computing unit 70, a deblock filter 71, a frame memory 72, a switch 73, an intra-prediction unit 74, an intra-template motion prediction/compensation unit 75, an intra-predicted motion vector generating unit 76, a motion prediction/compensation unit 77, an inter-template motion prediction/compensation unit 78, an inter-predicted motion vector generating unit 79, a predicted image selecting unit 80, and a rate control unit 81.

It should be noted that hereinafter, the intra-template motion prediction/compensation unit 75 and the inter-template motion prediction/compensation unit 78 will be referred to as intra-TP motion prediction/compensation unit 75 and inter-TP motion prediction/compensation unit 78, respectively.

The image encoding apparatus 51 compresses and encodes images in, for example, H. 264 and MPEG-4 Part10 (Advanced Video Coding) (hereinafter denoted as H.264/AVC) format.

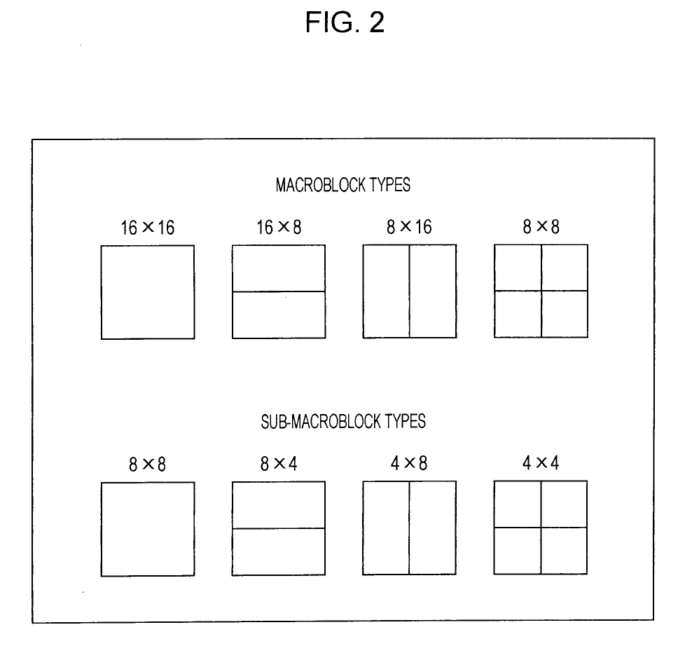

In H.264/AVC format, motion prediction/compensation is performed while making the block size variable. That is, in H.264/AVC format, as shown in FIG. 2, it is possible to divide a single macroblock made up of 16×16 pixels into one of 16×16 pixel, 16×8 pixel, 8×16 pixel, and 8×8 pixel partitions, each having independent motion vector information. Also, for the 8×8 pixel partition, as shown in FIG. 2, it is possible to divide the partition into one of 8×8 pixel, 8×4 pixel, 4×8 pixel, and 4×4 pixel sub-partitions, each having independent motion vector information.

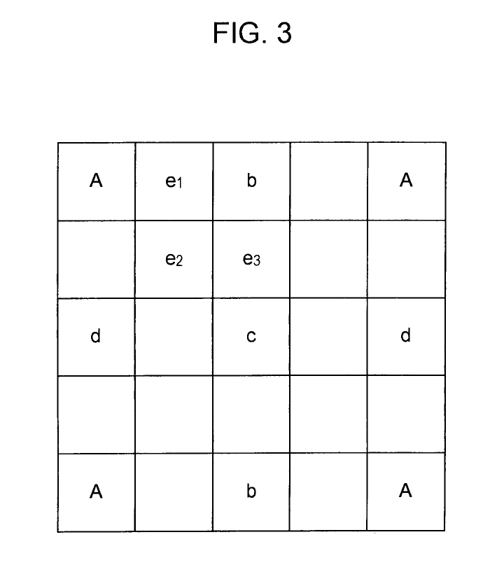

Also, in H.264/AVC format, a prediction/compensation process with ¼ pixel precision using a 6-tap FIR (Finite Impulse Response Filter) filter is performed. Referring to FIG. 3, a prediction/compensation process with decimal pixel precision in H.264/AVC format will be described.

In the example in FIG. 3, position A indicates a position of an integer precision pixel, positions b, c, and d indicate positions at ½ pixel precision, and positions e1, e2, and e3 indicate positions at ¼ pixel precision. First, in the following, Clip( ) is defined as in Expression (1) below.

$$\begin{matrix}[ Eq . 1 ] & \\ Clip 1 ( a ) = \{ \begin{matrix}0 ; & if ( a < 0 ) \\ a ; & otherwise \\ max\_pix ; & if ( a > max\_pix )\end{matrix} & ( 1 )\end{matrix}$$

It should be noted that when an input image has 8-bit precision, the value of max_pix is 255.

The pixel value at each of positions b and d is generated as in Expression (2) below, by using a 6-tap FIR filter.

[Eq. 2]

F=A₋₂−5·A₋₁+20·A₀+20·A₁−5·A₂+A₃

b, d=Clip1((F+16)>>5) (2)

The pixel value at position c is generated as in Expression (3) below, through application of the 6-tap FIR filter in the horizontal direction and in the vertical direction.

[Eq. 3]

F=b₋₂−5·b₋₁+20·b₀+20·b₁−5·b₂+b₃

else

F=d₋₂−5·d₋₁+20·d₀+20·d₁−5·d₂+d₃

c=Clip1((F+512)>>10) (3)

It should be noted that the Clip process is executed only once at the end after product-sum processes in the horizontal direction and in the vertical direction are both performed.

Positions e1 to e3 are generated by linear interpolation as in Expression (4) below.

[Eq. 4]

e₁=(A+b+1)>>1

e₂=(b+d+1)>>1

e₃=(b+c+1)>>1 (4)

Returning to FIG. 1, the A/D conversion unit 61 performs A/D conversion on an inputted image, and outputs the resulting image to the screen rearrangement buffer 62 for storage. The screen rearrangement buffer 62 rearranges stored images in the display order of frames into the order of frames for encoding, in accordance with GOP (Group of Picture).

The computing unit 63 subtracts, from an image read from the screen rearrangement buffer 62, a predicted image from the intra-prediction unit 74 or a predicted image from the motion prediction/compensation unit 77, which is selected by the predicted image selecting unit 80, and outputs the resulting difference information to the orthogonal transform unit 64. The orthogonal transform unit 64 applies an orthogonal transform such as a discrete cosine transform or Karhunen Loeve transform to the difference information from the computing unit 63, and outputs the resulting transform coefficients. The quantization unit 65 quantizes the transform coefficients outputted by the orthogonal transform unit 64.

The quantized transform coefficients, which are the output of the quantization unit 65, are inputted to the reversible encoding unit 66, where the transform coefficients are subjected to reversible encoding such as variable length encoding or arithmetic encoding, and compressed. It should be noted that the compressed images are outputted after being accumulated in the accumulation buffer 67. The rate control unit 81 controls the quantizing operation of the quantization unit 65 on the basis of the compressed images accumulated in the accumulation buffer 67.

Also, the quantized transform coefficients outputted from the quantization unit 65 are also inputted to the inverse quantization unit 68, and after inverse quantization, are further subjected to an inverse orthogonal transform in the inverse orthogonal transform unit 69. The inverse orthogonal transformed output is summed with a predicted image supplied from the predicted image selecting unit 80 by the computing unit 70, resulting in a locally decoded image. After removing block distortions in the decoded image, the deblock filter 71 supplies the resulting image to the frame memory 72 for accumulation. The image prior to the deblock filtering process by the deblock filter 72 is also supplied to the frame memory 72 for accumulation.

The switch 73 outputs reference images accumulated in the frame memory 72 to the motion prediction/compensation unit 77 or the intra-prediction unit 74.

In the image encoding apparatus 51, for example, I-pictures, B-pictures, and P-pictures from the screen rearrangement buffer 62 are supplied to the intra-prediction unit 74 as images subject to intra-prediction (also referred to as intra-process). Also, B-pictures and P-pictures read from the screen rearrangement buffer 62 are supplied to the motion prediction/compensation unit 77 as images subject to inter-prediction (also referred to as inter-process).

The intra-prediction unit 74 performs intra-prediction processes in all candidate intra-prediction modes, on the basis of an image to be intra-predicted read from the screen rearrangement buffer 62 and reference images supplied from the frame memory 72, thereby generating predicted images.

Also, the intra-prediction unit 74 supplies the image to be intra-predicted read from the screen rearrangement buffer 62, and the reference images supplied from the frame memory 72 via the switch 73, to the intra-TP motion prediction/compensation unit 75.

The intra-prediction unit 74 computes cost function values for all the candidate intra-prediction modes. The intra-prediction unit 74 determines, as the optimal intra-prediction mode, a prediction mode that gives the minimum value, among the computed cost function values, and a cost function value for intra-template prediction mode computed by the intra-TP motion prediction/compensation unit 75.

The intra-prediction unit 74 supplies a predicted image generated in the optimal intra-prediction mode, and its cost function value to the predicted image selecting unit 80. If the predicted image generated in the optimal intra-prediction mode is selected by the predicted image selecting unit 80, the intra-prediction unit 74 supplies information on the optimal intra-prediction mode to the reversible encoding unit 66. The reversible encoding unit 66 encodes this information for use as part of header information in the compressed image.

The intra-TP motion prediction/compensation unit 75 performs a motion prediction and compensation process in intra-template prediction mode on the basis of an image to be intra-predicted read from the screen rearrangement buffer 62, and reference images supplied from the frame memory 72, thereby generating a predicted image. At that time, the intra-TP motion prediction/compensation unit 75 performs motion prediction within a predetermined search range around predicted motion vector information generated by the intra-predicted motion vector generating unit 76. That is, in the intra-TP motion prediction/compensation unit 75, motion prediction is performed within a predetermined search range centered on predicted motion vector information.

The motion vector information calculated by the motion prediction in intra-template prediction mode (hereinafter, also referred to as intra-motion vector information) is stored into a built-in memory (not shown) of the intra-TP motion prediction/compensation unit 75.

Also, the intra-TP motion prediction/compensation unit 75 computes a cost function value for intra-template prediction mode, and supplies the computed function value and the predicted image to the intra-prediction unit 74.

The intra-predicted motion vector generating unit 76 generates predicted motion vector information (hereinafter, also referred to as predicted value of a motion vector as appropriate) for a current block, by using intra-motion vector information on previously encoded blocks, which is stored in the built-in memory of the intra-TP motion prediction/compensation unit 75. For the generation of the predicted motion vector information, for example, intra-motion vector information on blocks adjacent to the current block is used.

The motion prediction/compensation unit 77 performs motion prediction/compensation processes in all candidate inter-prediction modes. That is, the motion prediction/compensation unit 77 detects motion vectors in all the candidate inter-prediction modes, on the basis of an image to be inter-predicted read from the screen rearrangement buffer 62, and reference images supplied from the frame memory 72 via the switch 73, and applies a motion prediction and compensation process to the reference images on the basis of the motion vectors, thereby generating predicted images.

Also, the motion prediction/compensation unit 77 supplies the image to be inter-predicted read from the screen rearrangement buffer 62, and the reference images supplied from the frame memory 72 via the switch 73, to the inter-TP motion prediction/compensation unit 78.

The motion prediction/compensation unit 77 computes cost function values for all the candidate inter-prediction modes. The motion prediction/compensation unit 77 determines, as the optimal inter-prediction mode, a prediction mode that gives the minimum value, among the computed cost function values for inter-prediction modes, and a cost function value for inter-template prediction mode computed by the inter-TP motion prediction/compensation unit 78.

The motion prediction/compensation unit 77 supplies a predicted image generated in the optimal inter-prediction mode, and its cost function value to the predicted image selecting unit 80. If the predicted image generated in the optimal inter-prediction mode is selected by the predicted image selecting unit 80, the motion prediction/compensation unit 77 supplies information on the optimal inter-prediction mode, and information according to the optimal inter-prediction mode (motion vector information, reference frame information, and the like) to the reversible encoding unit 66. The reversible encoding unit 66 likewise applies a reversible encoding process such as variable length encoding and arithmetic encoding to the information from the motion prediction/compensation unit 77, and inserts the resulting information into the header part of the compressed image.

The inter-TP motion prediction/compensation unit 78 performs a motion prediction and compensation process in inter-template prediction mode on the basis of an image to be inter-predicted read from the screen rearrangement buffer 62, and reference images supplied from the frame memory 72, thereby generating a predicted image. At that time, the inter-TP motion prediction/compensation unit 78 performs motion prediction within a predetermined search range around predicted motion vector information generated by the inter-predicted motion vector generating unit 79. That is, in the inter-TP motion prediction/compensation unit 78, motion prediction is performed within a predetermined search range centered on predicted motion vector information.

The motion vector information calculated by the motion prediction in inter-template prediction mode (hereinafter, also referred to as inter-motion vector information) is stored into a built-in memory (not shown) of the inter-TP motion prediction/compensation unit 78.

Also, the inter-TP motion prediction/compensation unit 78 computes a cost function value for inter-template prediction mode, and supplies the computed function value and the predicted image to the motion prediction/compensation unit 77.

The inter-predicted motion vector generating unit 79 generates predicted motion vector information for a current block, by using inter-motion vector information on previously encoded blocks, which is stored in the built-in memory of the inter-TP motion prediction/compensation unit 78. For the generation of the predicted motion vector information, for example, inter-motion vector information on blocks adjacent to the current block is used.

The predicted image selecting unit 80 determines an optimal prediction mode from among the optimal intra-prediction mode and the optimal inter-prediction mode, on the basis of the cost function values outputted from the intra-prediction unit 74 or the motion prediction/compensation unit 77. The predicted image selecting unit 80 selects a predicted image in the determined optimal prediction mode, and supplies the predicted image to the computing units 63 and 70. At this time, the predicted image selecting unit 80 supplies selection information of the predicted image to the intra-prediction unit 74 or the motion prediction/compensation unit 77.

The rate control unit 81 controls the rate of the quantizing operation of the quantization unit 65 on the basis of compressed images accumulated in the accumulation buffer 67, so that overflow or underflow does not occur.

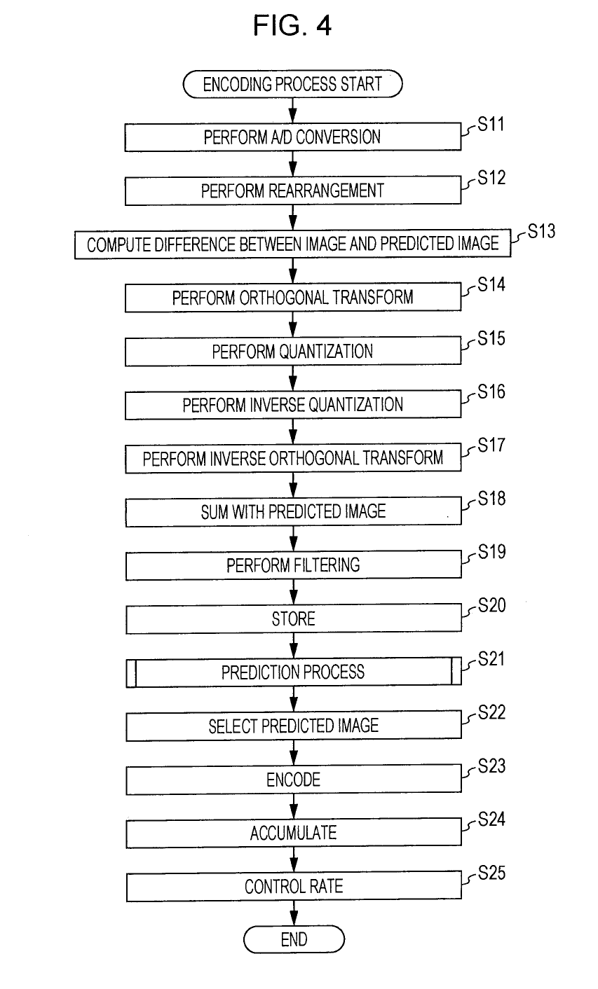

Next, referring to the flowchart in FIG. 4, an encoding process in the image encoding apparatus 51 in FIG. 1 will be described.

In step S11, the A/D conversion unit 61 performs A/D conversion on an inputted image. In step S12, the screen rearrangement buffer 62 stores each image supplied from the A/D conversion unit 61, and performs rearrangement from the order in which pictures are displayed to the order in which the pictures are encoded.

In step S13, the computing unit 63 computes the difference between each image rearranged in step S12 and a predicted image. The predicted image is supplied to the computing unit 63 via the predicted image selecting unit 80, from the motion prediction/compensation unit 77 in the case of performing inter-prediction, and from the intra-prediction unit 74 in the case of performing intra-prediction.

The difference data has a small data size in comparison to the original data image. Therefore, the data size can be compressed in comparison to the case of encoding an image as it is.

In step S14, the orthogonal transform unit 64 performs an orthogonal transform on the difference information supplied from the computing unit 63. More specifically, an orthogonal transform such as a discrete cosine transform or Karhunen Loeve transform is performed, and transform coefficients are outputted. In step S15, the quantization unit 65 quantizes the transform coefficients. In this quantization, as will be described later in the process of step S25, rate is controlled.

The difference information quantized as described above is locally decoded in the following manner. That is, in step S16, the inverse quantization unit 68 performs inverse quantization on the transform coefficients quantized by the quantization unit 65, in accordance with characteristics corresponding to the characteristics of the quantization unit 65. In step S17, the inverse orthogonal transform unit 69 performs an inverse orthogonal transform on the transform coefficients inverse quantized by the inverse quantization unit 68, in accordance with characteristics corresponding to the characteristics of the orthogonal transform unit 64.

In step S18, the computing unit 70 sums a predicted image inputted via the predicted image selecting unit 80, with the locally decoded difference information, thereby generating a locally decoded image (corresponding to the input to the computing unit 63). In step S19, the deblock filter 71 performs filtering on the image outputted by the computing unit 70. Block distortions are thus removed. In step S20, the frame memory 72 stores the filtered image. It should be noted that an image not filtered by the deblock filter 71 is also supplied from the computing unit 70 to the frame memory 72 for storage.

In step S21, the intra-prediction unit 74, the intra-TP motion prediction/compensation unit 75, the motion prediction/compensation unit 77, and the inter-TP motion prediction/compensation unit 78 each perform an image prediction process. That is, in step S21, the intra-prediction unit 74 performs an intra-prediction process in intra-prediction mode, and the intra-TP motion prediction/compensation unit 75 performs a motion prediction/compensation process in intra-template prediction mode. Also, the motion prediction/compensation unit 77 performs a motion prediction/compensation process in inter-prediction mode, and the inter-TP motion prediction/compensation unit 78 performs a motion prediction/compensation process in inter-template prediction mode.

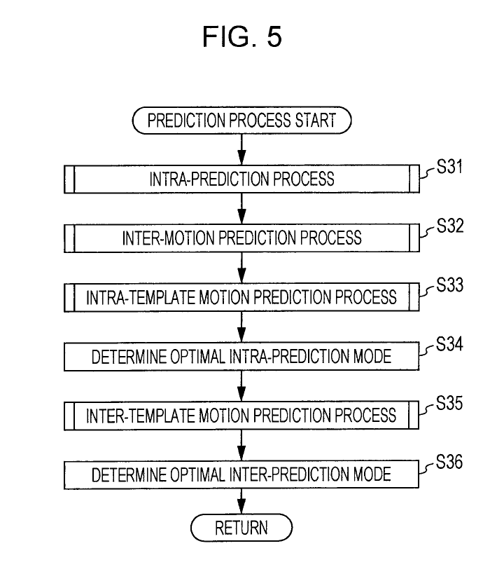

Although details of the prediction process in step S21 will be described later with reference to FIG. 5, through this process, prediction processes in all the candidate prediction modes are performed, and cost function values in all the candidate prediction modes are computed. Then, on the basis of the computed cost function values, the optimal intra-prediction mode is selected, and a predicted image generated by intra-prediction in the optimal intra-prediction mode, and its cost function value are supplied to the predicted image selecting unit 80. Also, on the basis of the computed cost function values, the optimal inter-prediction mode is determined from among the inter-prediction modes and inter-template prediction mode, and a predicted image generated in the optimal inter-prediction mode, and its cost function value are supplied to the predicted image selecting unit 80.

In step S22, the predicted image selecting unit 80 determines one of the optimal intra-prediction mode and the optimal inter-prediction mode as the optimal prediction mode, on the basis of the cost function values outputted by the intra-prediction unit 74 and the motion prediction/compensation unit 77, selects a predicted image in the determined optimal prediction mode, and supplies the predicted image to the computing units 63 and 70. As described above, this predicted image is used for the computations in steps S13 and S18.

It should be noted that selection information of this predicted image is supplied to the intra-prediction unit 74 or the motion prediction/compensation unit 77. When a predicted image in the optimal intra-prediction mode is selected, the intra-prediction unit 74 supplies information on the optimal intra-prediction mode (that is, intra-prediction mode information or intra-template prediction mode information) to the reversible encoding unit 66.

When a predicted image in the optimal inter-prediction mode is selected, the motion prediction/compensation unit 77 supplies information on the optimal inter-prediction mode, and information according to the optimal inter-prediction mode (such as motion vector information and reference frame information) to the reversible encoding unit 66. That is, when a predicted image in inter-prediction mode is selected as the optimal inter-prediction mode, the motion prediction/compensation unit 77 outputs inter-prediction mode information, motion vector information, and reference frame information to the reversible encoding unit 66. On the other hand, when a predicted image in inter-template prediction mode is selected as the optimal inter-prediction mode, the motion prediction/compensation unit 77 outputs inter-template prediction mode information to the reversible encoding unit 66.

In step S23, the reversible encoding unit 66 encodes quantized transform coefficients outputted by the quantization unit 65. That is, the difference image is subjected to reversible encoding such as variable length encoding or arithmetic encoding, and compressed. At this time, the information on the optimal intra-prediction mode from the intra-prediction unit 74, the information according to the optimal inter-prediction mode (such as prediction mode information, motion vector information, and reference frame information) from the motion prediction/compensation unit 77, and the like, which are inputted to the reversible encoding unit 66 in step S22 described above, are also encoded, and attached to header information.

In step S24, the accumulation buffer 67 accumulates the difference image as a compressed image. Compressed images accumulated in the accumulation buffer 67 are read as appropriate, and transmitted to the decoding side via a transmission path.

In step S25, the rate control unit 81 controls the rate of the quantizing operation of the quantization unit 65 on the basis of the compressed images accumulated in the accumulation buffer 67, so that overflow or underflow does not occur.

Next, referring to the flowchart in FIG. 5, the prediction process in step S21 in FIG. 4 will be described.

If an image to be processed supplied from the screen rearrangement buffer 62 is an image of a block to be intra-processed, previously decoded images to be referenced are read from the frame memory 72, and supplied to the intra-prediction unit 74 via the switch 73. On the basis of these images, in step S31, the intra-prediction unit 74 intra-predicts the pixels of the block to be processed, in all candidate intra-prediction modes. It should be noted that as previously decoded pixels to be referenced, pixels to which deblock filtering has not been applied by the deblock filter 71 are used.

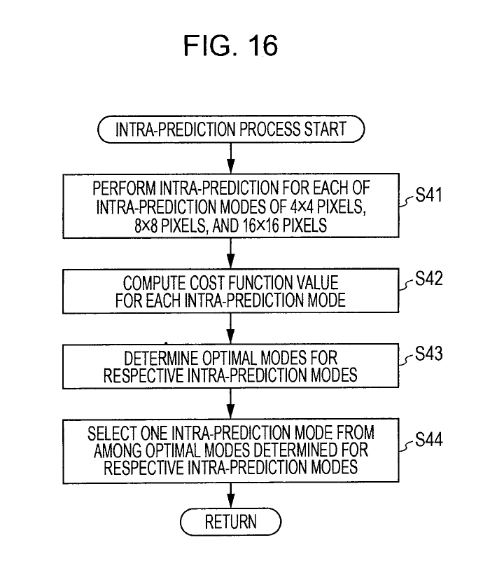

Although details of the intra-prediction process in step S31 will be described later with reference to FIG. 16, through this process, intra-prediction is performed in all candidate intra-prediction modes, and cost function values are computed for all the candidate intra-prediction modes. Then, on the basis of the computed cost function values, one intra-prediction mode that is considered optimal is selected from among all the intra-prediction modes.

If an image to be processed supplied from the screen rearrangement buffer 62 is an image to be inter-processed, images to be referenced are read from the frame memory 72, and supplied to the motion prediction/compensation unit 77 via the switch 73. On the basis of these images, in step S32, the motion prediction/compensation unit 77 performs an inter-motion prediction process. That is, the motion prediction/compensation unit 77 performs motion prediction processes in all candidate inter-prediction modes, by referencing the image supplied from the frame memory 72.

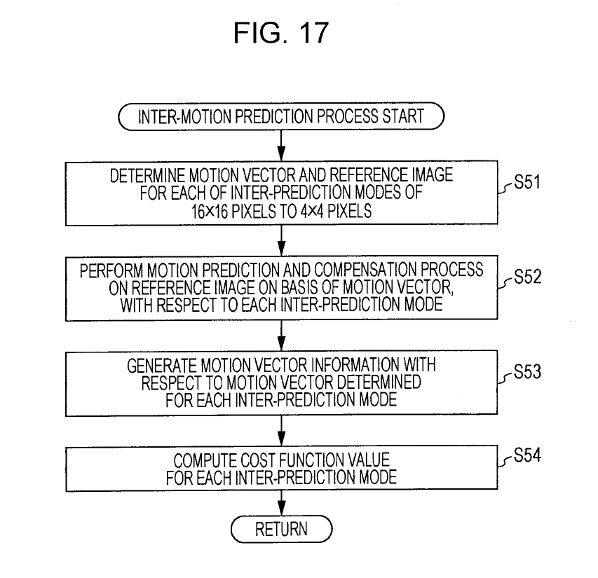

Although details of the inter-motion prediction process in step S32 will be described later with reference to FIG. 17, through this process, motion prediction processes are performed in all the candidate inter-prediction modes, and cost function values are computed for all the candidate inter-prediction modes.

Also, if an image to be processed supplied from the screen rearrangement buffer 62 is an image of a block to be intra-processed, previously decoded images to be referenced read from the frame memory 72 are also supplied to the intra-TP motion prediction/compensation unit 75 via the intra-prediction unit 74. On the basis of these images, in step S33, the intra-TP motion prediction/compensation unit 75 performs an intra-template motion prediction process in intra-template prediction mode.

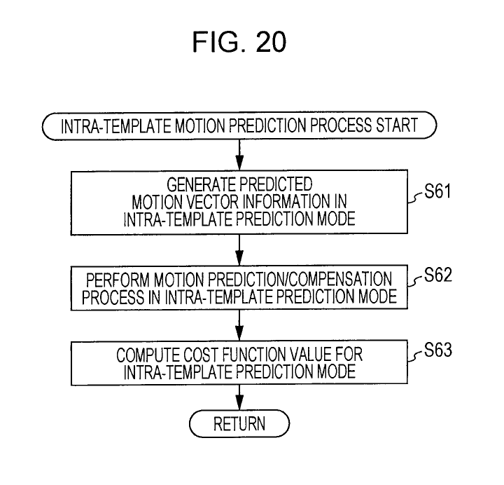

Although details of the intra-template motion prediction process in step S33 will be described later with reference to FIG. 20, through this process, a motion prediction process is performed in intra-template prediction mode, and a cost function value is computed for intra-template prediction mode. Then, a predicted image generated by the motion prediction process in intra-template prediction mode, and its cost function value are supplied to the intra-prediction unit 74.

In step S34, the intra-prediction unit 74 compares the cost function value for the intra-prediction mode selected in step S31, with the cost function value for intra-template prediction mode computed in step S33, and determines the prediction mode that gives the minimum value as the optimal intra-prediction mode. Then, the intra-prediction unit 74 supplies a predicted image generated in the optimal intra-prediction mode, and its cost function value to the predicted image selecting unit 80.

Further, if an image to be processed supplied from the screen rearrangement buffer 62 is an image to be inter-processed, images to be referenced read from the frame memory 72 are also supplied to the inter-TP motion prediction/compensation unit 78 via the switch 73 and the motion prediction/compensation unit 77. On the basis of these images, in step S35, the inter-TP motion prediction/compensation unit 78 performs an inter-template motion prediction process in inter-template prediction mode.

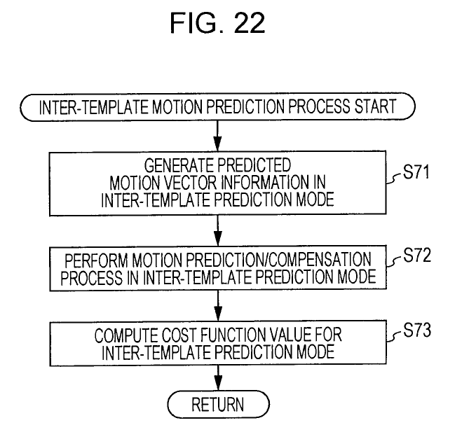

Although details of the inter-template motion prediction process in step S35 will be described later with reference to FIG. 22, through this process, a motion prediction process is performed in inter-template prediction mode, and a cost function value is computed for inter-template prediction mode. Then, a predicted image generated by the motion prediction process in inter-template prediction mode, and its cost function value are supplied to the motion prediction/compensation unit 77.

In step S36, the motion prediction/compensation unit 77 compares the cost function value for the optimal inter-prediction mode selected in step S32, with the cost function value for inter-template prediction mode computed in step S35, and determines the prediction mode that gives the minimum value as the optimal inter-prediction mode. Then, the motion prediction/compensation unit 77 supplies a predicted image generated in the optimal inter-prediction mode, and its cost function value to the predicted image selecting unit 80.

Next, individual modes of intra-prediction defined in H.264/AVC format will be described.

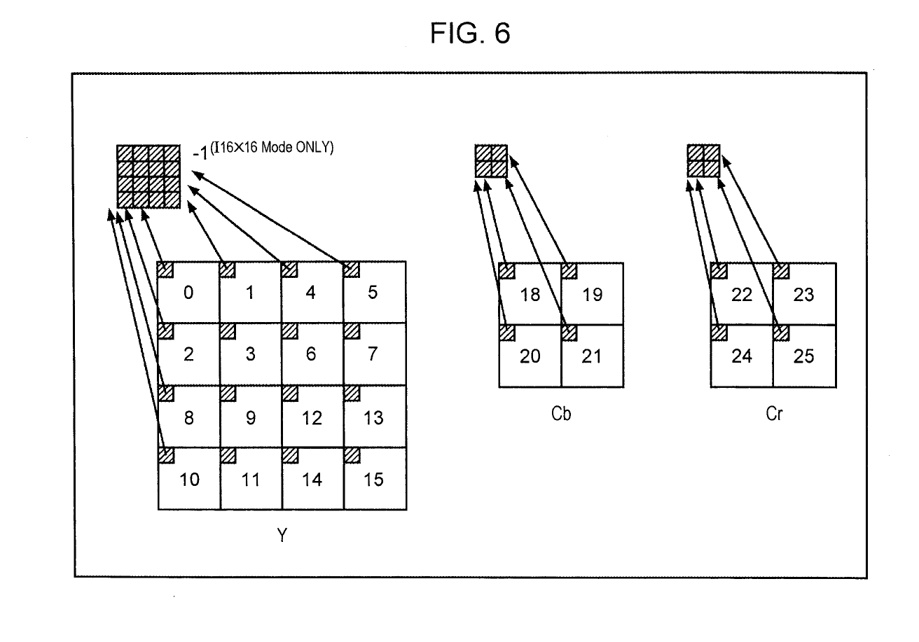

First, intra-prediction modes for luminance signals will be described. As intra-prediction modes for luminance signals, there are 9 kinds of prediction modes in 4×4 pixel block units, and 4 kinds of prediction modes in 16×16 pixel macroblock units. As shown in FIG. 6, in the case of intra-prediction modes of 16×16 pixels, the DC components of individual blocks are collected to generate a 4×4 matrix, which is further subjected to an orthogonal transform.

It should be noted that for High Profile, prediction modes in 8×8 pixel block units are defined for 8-th order DCT blocks. This format conforms to the format of the intra-prediction modes of 4×4 pixels described below.

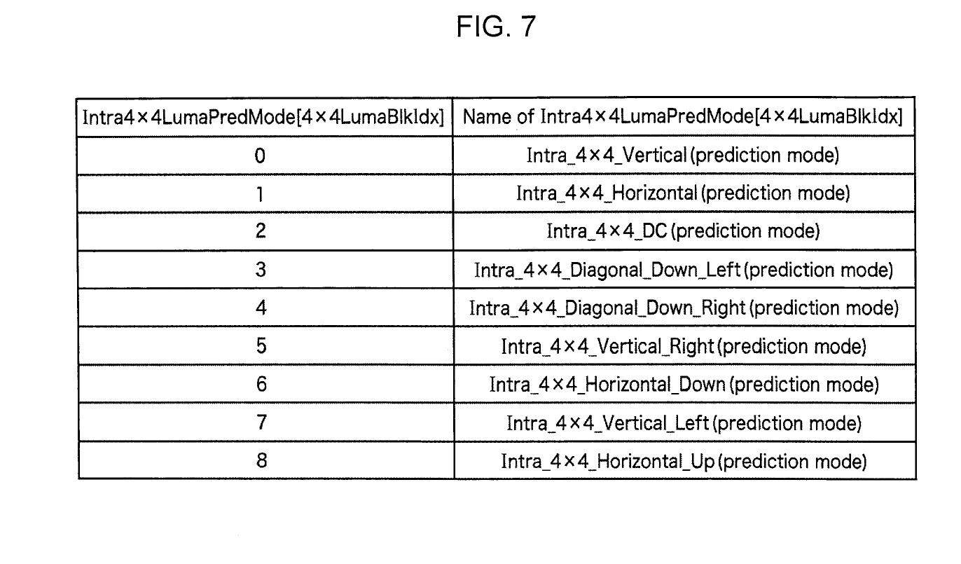

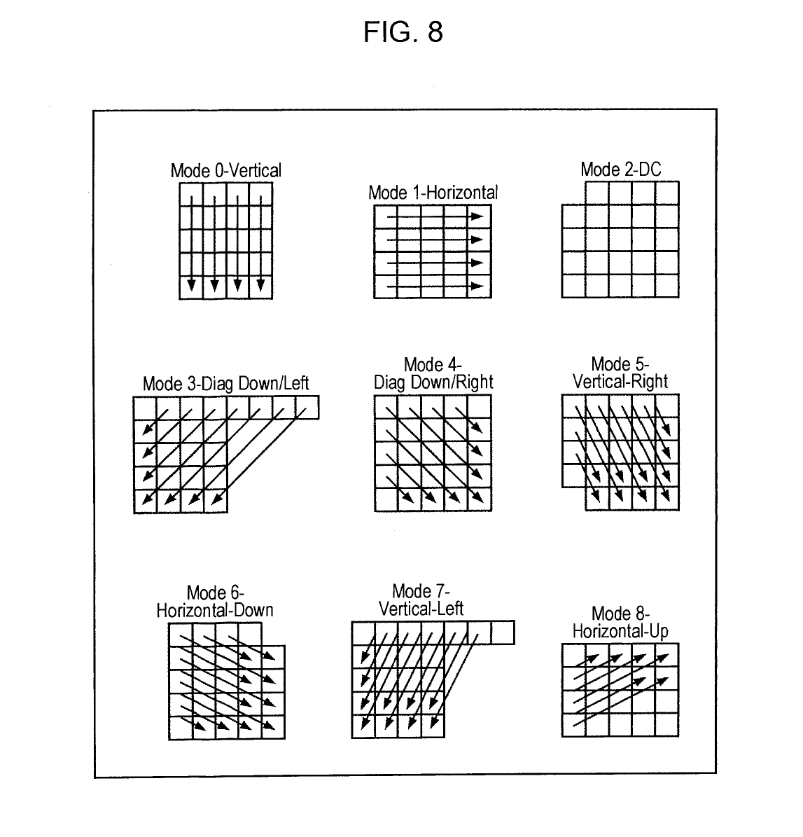

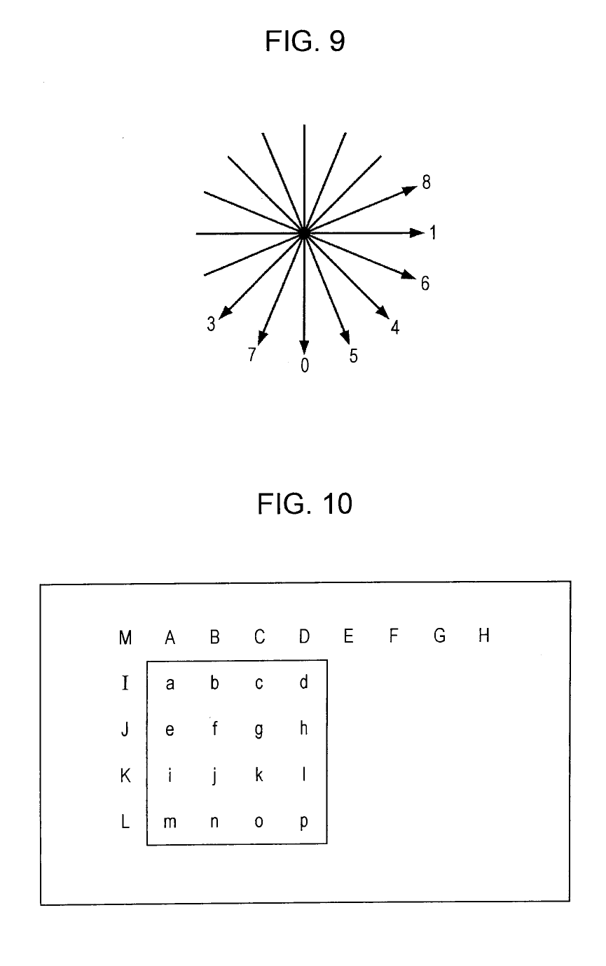

FIGS. 7 and 8 are diagrams showing the 9 kinds of intra-prediction modes of 4×4 pixels (Intra_{—}4×4_pred_mode) for luminance signals. The 8 kinds of modes other than Mode 2 indicating mean (DC) prediction correspond to directions indicated by numbers 0, 1, and 3 to 8 in FIG. 9, respectively.

The 9 kinds of Intra_{—}4×4_pred_mode will be described with reference to FIG. 10. In the example in FIG. 10, pixels a to p represent the pixels of a block to be intra-processed, and pixel values A to M represent the pixel values of pixels belonging to adjacent blocks. That is, pixels a to p represent an image to be processed read from the screen rearrangement buffer 62, and pixel values A to M represent the pixel values of previously decoded images that are read from the frame memory 72 and referenced.

In the case of the intra-prediction modes in FIGS. 7 and 8, the predicted pixel values of pixels a to p are generated as follows by using the pixel values A to M of the pixels belonging to the adjacent blocks. It should be noted that when a pixel value is “available”, this indicates that the pixel value is available, without reasons such as the pixel being at the edge of a picture frame or not having been encoded yet, and when a pixel value is “unavailable”, this indicates that the pixel value is unavailable for reasons such as the pixel being at the edge of a picture frame or not having been encoded yet.

Mode 0 is Vertical Prediction, which is applied only when pixel values A to D are “available”. In this case, the predicted pixel values of pixels a to p are generated as in Expression (5) below.

Predicted pixel value of pixel a, e, i, m=A

Predicted pixel value of pixel b, f, j, n=B

Predicted pixel value of pixel c, g, k, o=C

Predicted pixel value of pixel d, h, l, p=D (5)

Mode 1 is Horizontal Prediction, which is applied only when pixel values I to L are “available”. In this case, the predicted pixel values of pixels a to p are generated as in Expression (6) below.

Predicted pixel value of pixel a, b, c, d=I

Predicted pixel value of pixel e, f, g, h=J

Predicted pixel value of pixel i, j, k, l=K

Predicted pixel value of pixel m, n, o, p=L (6)

Mode 2 is DC Prediction, and when pixel values A, B, C, D, I, J, K, and L are all “available”, predicted pixel values are generated as in Expression (7) below.

(A+B+C+D+I+J+K+L+4)>>3 (7)

Also, when pixel values A, B, C, and D are all “unavailable”, predicted pixel values are generated as in Expression (8) below.

(I+J+K+L+2)>>2 (8)

Also, when pixel values I, J, K, and L are all “unavailable”, predicted pixel values are generated as in Expression (9) below.

(A+B+C+D+2)>>2 (9)

It should be noted that when pixel values A, B, C, D, I, J, K, and L are all “unavailable”, 128 is used as a predicted pixel value.

Mode 3 is Diagonal_Down_Left Prediction, which is applied only when pixel values A, B, C, D, I, J, K, L, and M are “available”. In this case, the predicted pixel values of pixels a to p are generated as in Expression (10) below.

Predicted pixel value of pixel a=(A+2B+C+2)>>2

Predicted pixel value of pixel b, e=(B+2C+D+2)>>2

Predicted pixel value of pixel c, f, i=(C+2D+E+2)>>2

Predicted pixel value of pixel d, g, j, m=(D+2E+F+2)>>2

Predicted pixel value of pixel h, k, n=(E+2F+G+2)>>2

Predicted pixel value of pixel l, o=(F+2G+H+2)>>2

Predicted pixel value of pixel p=(G+3H+2)>>2 (10)

Mode 4 is Diagonal_Down_Right Prediction, which is applied only when pixel values A, B, C, D, I, J, K, L, and M are “available”. In this case, the predicted pixel values of pixels a to p are generated as in Expression (11) below.

Predicted pixel value of pixel m=(J+2K+L+2)>>2

Predicted pixel value of pixel i, n=(I+2J+K+2)>>2

Predicted pixel value of pixel e, j, o=(M+2I+J+2)>>2

Predicted pixel value of pixel a, f, k, p=(A+2M+I+2)>>2

Predicted pixel value of pixel b, g, l=(M+2A+B+2)>>2

Predicted pixel value of pixel c, h=(A+2B+C+2)>>2

Predicted pixel value of pixel d=(B+2C+D+2)>>2 (11)

Mode 5 is Diagonal_Vertical_Right Prediction, which is applied only when pixel values A, B, C, D, I, J, K, L, and M are “available”. In this case, the predicted pixel values of pixels a to p are generated as in Expression (12) below.

Predicted pixel value of pixel a, j=(M+A+1)>>1

Predicted pixel value of pixel b, k=(A+B+1)>>1

Predicted pixel value of pixel c, l=(B+C+1)>>1

Predicted pixel value of pixel d=(C+D+1)>>1

Predicted pixel value of pixel e, n=(I+2M+A+1)>>2

Predicted pixel value of pixel f, o=(M+2A+B+2)>>2

Predicted pixel value of pixel g, p=(A+2B+C+2)>>2

Predicted pixel value of pixel h=(B+2C+D+2)>>2

Predicted pixel value of pixel i=(M+2I+J+2)>>2

Predicted pixel value of pixel m=(I+2J+K+2)>>2 (12)

Mode 6 is Horizontal_Down Prediction, which is applied only when pixel values A, B, C, D, I, J, K, L, and M are “available”. In this case, the predicted pixel values of pixels a to p are generated as in Expression (13) below.

Predicted pixel value of pixel a, g=(M+I+1)>>1

Predicted pixel value of pixel b, h=(I+2M+A+2)>>2

Predicted pixel value of pixel c=(M+2A+B+2)>>2

Predicted pixel value of pixel d=(A+2B+C+2)>>2

Predicted pixel value of pixel e, k=(I+J+1)>>1

Predicted pixel value of pixel f, l=(M+2I+J+1)>>2

Predicted pixel value of pixel i, o=(J+K+1)>>1

Predicted pixel value of pixel j, p=(I+2J+K+2)>>2

Predicted pixel value of pixel m=(K+L+1)>>1

Predicted pixel value of pixel n=(J+2K+L+2)>>2 (13)

Mode 7 is Vertical_Left Prediction, which is applied only when pixel values A, B, C, D, I, J, K, L, and M are “available”. In this case, the predicted pixel values of pixels a to p are generated as in Expression (14) below.

Predicted pixel value of pixel a=(A+B+1)>>1

Predicted pixel value of pixel b, i=(B+C+1)>>1

Predicted pixel value of pixel c, j=(C+D+1)>>1

Predicted pixel value of pixel d, k=(D+E+1)>>1

Predicted pixel value of pixel l=(E+F+1)>>1

Predicted pixel value of pixel e=(A+2B+C+2)>>2

Predicted pixel value of pixel f, m=(B+2C+D+2)>>2

Predicted pixel value of pixel g, n=(C+2D+E+2)>>2

Predicted pixel value of pixel h, o=(D+2E+F+2)>>2

Predicted pixel value of pixel p=(E+2F+G+2)>>2 (14)

Mode 8 is Horizontal_Up Prediction, which is applied only when pixel values A, B, C, D, I, J, K, L, and M are “available”. In this case, the predicted pixel values of pixels a to p are generated as in Expression (15) below.

Predicted pixel value of pixel a=(I+J+1)>>1

Predicted pixel value of pixel b=(I+2J+K+2)>>2

Predicted pixel value of pixel c, e=(J+K+1)>>1

Predicted pixel value of pixel d, f=(J+2K+L+2)>>2

Predicted pixel value of pixel g, i=(K+L+1)>>1

Predicted pixel value of pixel h, j=(K+3L+2)>>2

Predicted pixel value of pixel k, l, m, n, o, p=L (15)

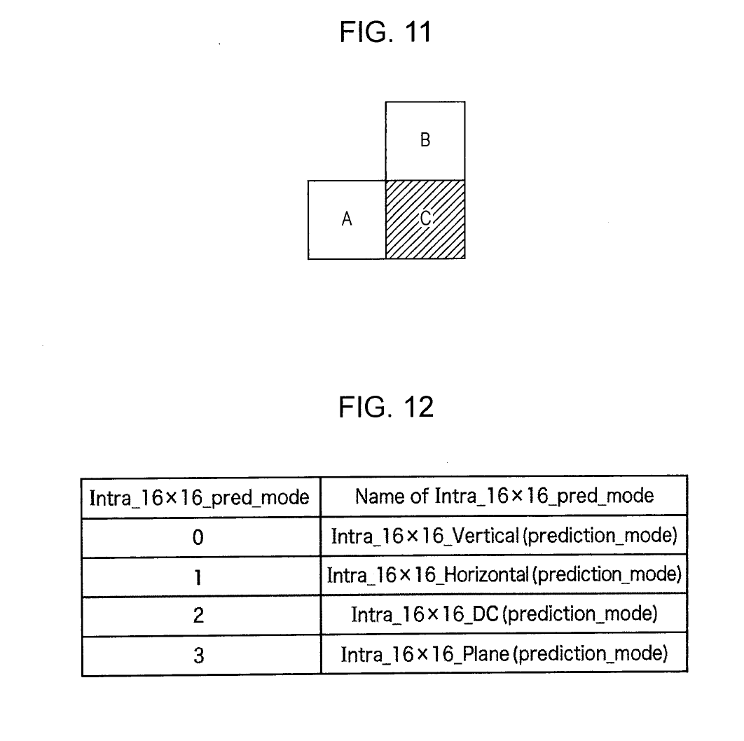

Next, referring to FIG. 11, the encoding format of intra-prediction modes of 4×4 pixels (Intra_{—}4×4_pred_mode) for luminance signals will be described.

In the example in FIG. 11, current block C to be encoded which is made up of 4×4 pixels is shown, and block A and block B each adjacent to current block C and made up of 4×4 pixels are shown.

In this case, Intra_{—}4×4_pred_mode in current block C, and Intra_{—}4×4_pred_mode each of in block A and block B are considered to have a high correlation. By performing an encoding process as described below by using this high correlation, higher encoding efficiency can be achieved.

That is, letting Intra_{—}4×4_pred_mode in block A and block B be Intra_{—}4×4_pred_modeA and Intra_{—}4×4_pred_modeB, respectively, MostProbableMode is defined as in Expression (16) below.

MostProbableMode=Min(Intra_{—}4×4_pred_modeA, Intra_{—}4×4_pred_modeB) (16)

That is, of block A and block B, the one that is assigned the smaller mode_number is defined as MostProbableMode.

In a bit stream, two values, prev_intra4×4_pred_mode_flag[luma4×4BlkIdx] and rem_intra4×4_pred_mode[luma4×4BlkIdx] are defined as parameters for current block C. By processing based on the pseudocode represented by Expression (17) below, a decoding process is performed, and the value of Intra_{—}4×4_pred_mode, Intra4×4PredMode[luma4×4BlkIdx] can be obtained.

if(prev_intra4×4_pred_mode_flag[luma4×4BlkIdx])Intra4×4PredMode[luma4×4BlkIdx]=MostProbableMode

else

if(rem_intra4×4_pred_mode[luma4×4BlkIdx]<MostProbableMode)

Intra4×4PredMode[luma4×4BlkIdx]=rem_intra4×4_pred_mode[luma4×4BlkIdx]

else

Intra4×4PredMode[luma4×4BlkIdx]=rem_intra4×4_pred_mode[luma4×4BlkIdx]+1 (17)

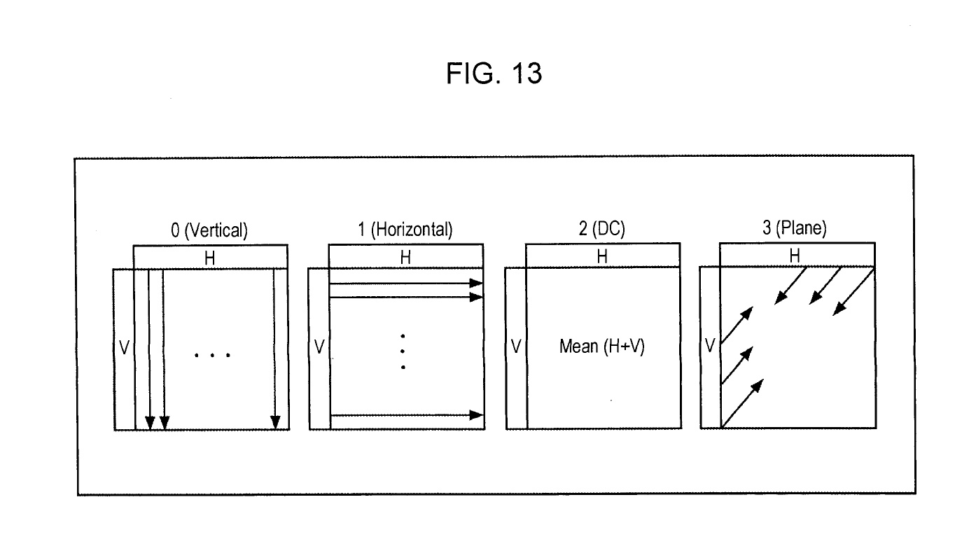

Next, intra-prediction modes of 16×16 pixels will be described. FIGS. 12 and 13 are diagrams showing 4 kinds of intra-prediction modes of 16×16 pixels (Intra_{—}16×16_pred_mode) for luminance signals.

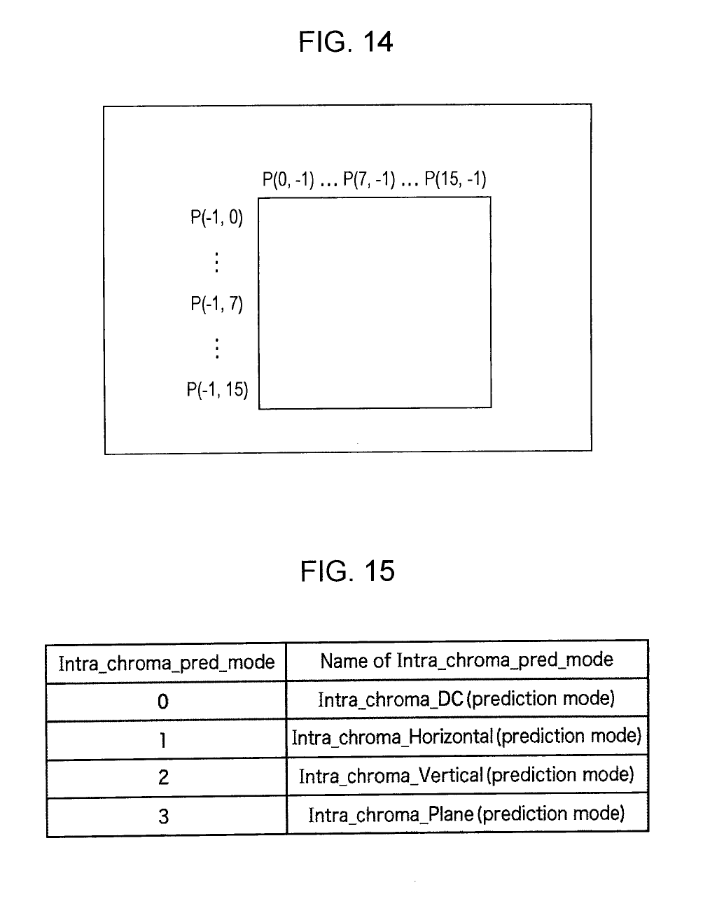

The 4 kinds of intra-prediction modes will be described with reference to FIG. 14. In the example in FIG. 14, current macroblock A to be intra-processed is shown, and P(x, y); x, y=−1, 0, . . . , 15 represent the pixel values of pixels adjacent to current macroblock A.

Mode 0 is Vertical Prediction, which is applied only when P(x, −1); x, y=−1, 0, . . . , 15 are “available”. In this case, the predicted pixel values Pred(x, y) of pixels in current macroblock A are generated as in Expression (18) below.

Pred(x, y)=P(x, −1); x, y=0, . . . , 15 (18)

Mode 1 is Horizontal Prediction, which is applied only when P(-1, y); x, y=−1, 0, . . . , 15 are “available”. In this case, the predicted pixel values Pred(x, y) of pixels in current macroblock A are generated as in Expression (19) below.

Pred(x, y)=P(−1, y); x, y=0, . . . , 15 (19)

Mode 2 is DC Prediction, and when P(x, −1) and P(−1, y); x, y=−1, 0, . . . , 15 are all “available”, the predicted pixel values Pred(x, y) of pixels in current macroblock A are generated as in Expression (20) below.

$$\begin{matrix}[ Eq . 5 ] & \\ Pred ( x , y ) = [ {\sum }_{{x}^{′} = 0}^{15} P ( {x}^{′} , - 1 ) + {\sum }_{{y}^{′} = 0}^{15} P ( - 1 , {y}^{′} ) + 16 ] >> 5 \\ with \\ x , y = 0 , … , 15 & ( 20 )\end{matrix}$$

Also, when P(x, −1); x, y=−1, 0, . . . , 15 are “unavailable”, the predicted pixel values Pred(x, y) of pixels in current macroblock A are generated as in Expression (21) below.

$$\begin{matrix}[ Eq . 6 ] & \\ Pred ( x , y ) = [ {\sum }_{{y}^{′} = 0}^{15} P ( - 1 , {y}^{′} ) + 8 ] >> 4 \\ with \\ x , y = 0 , … , 15 & ( 21 )\end{matrix}$$

When P(−1, y); x, y=−1, 0, . . . , 15 are “unavailable”, the predicted pixel values Pred(x, y) of pixels in current macroblock A are generated as in Expression (22) below.

$$\begin{matrix}[ Eq . 7 ] & \\ Pred ( x , y ) = [ {\sum }_{{y}^{′} = 0}^{15} P ( {x}^{′} , - 1 ) + 8 ] >> 4 \\ with \\ x , y = 0 , … , 15 & ( 22 )\end{matrix}$$

When P(x, −1) and P(−1, y); x, y=−1, 0, . . . , 15 are all “unavailable”, 128 is used as a predicted pixel value.

Mode 3 is Plane Prediction, which is applied only when P(x, −1) and P(−1, y); x, y=−1, 0, . . . , 15 are all “available”. In this case, the predicted pixel values Pred(x, y) of pixels in current macroblock A are generated as in Expression (23) below.

$$\begin{matrix}[ Eq . 8 ] & \\ Pred ( x , y ) = Clip 1 ( ( a + b \cdot ( x - 7 ) + c \cdot ( y - 7 ) + 16 ) >> 5 ) \\ a = 16 \cdot ( P ( - 1 , 15 ) + P ( 15 , - 1 ) ) \\ b = ( 5 \cdot H + 32 ) >> 6 \\ c = ( 5 \cdot V + 32 ) >> 6 \\ H = {\sum }_{x = 1}^{8} x \cdot ( P ( 7 + x , - 1 ) - P ( 7 - x , - 1 ) ) \\ V = {\sum }_{y = 1}^{8} y \cdot ( P ( - 1 , 7 + y ) - P ( - 1 , 7 - y ) ) & ( 23 )\end{matrix}$$

Next, intra-prediction modes for chrominance signals will be described. FIG. 15 is a diagram showing 4 kinds of intra-prediction modes (Intra_chroma_pred_mode) for chrominance signals. The intra-prediction modes for chrominance signals can be set independently from the intra-prediction modes for luminance signals. The intra-prediction modes for chrominance signals conform to the intra-prediction modes of 16×16 pixels for luminance signals described above.

It should be noted that while the intra-prediction modes of 16×16 pixels for luminance signals are applied to blocks of 16×16 pixels, the intra-prediction modes for chrominance signals are applied to blocks of 8×8 pixels. Further, as shown in FIGS. 12 and 15 mentioned above, mode numbers do not correspond to each other between the two.

In conformity to the definitions of the pixel values of current macroblock A in the intra-prediction modes of 16×16 pixels for luminance signals, and the adjacent pixel values described above with reference to FIG. 14, let the pixel values of pixels adjacent to current macroblock A to be intra-processed (in the case of chrominance signals, 8×8 pixels) be P(x, y); x, y=−1, 0, . . . , 7.

Mode 0 is DC prediction, and when P(x, −1) and P(−1, y); x, y=−1, 0, . . . , 7 are all “available”, the predicted pixel values Pred(x, y) of pixels in current macroblock A are generated as in Expression (24) below.

$$\begin{matrix}[ Eq . 9 ] & \\ Pred ( x , y ) = ( ( {\sum }_{n = 0}^{7} ( P ( - 1 , n ) + P ( n , - 1 ) ) ) + 8 ) >> 4 \\ with \\ x , y = 0 , … , 7 & ( 24 )\end{matrix}$$

Also, when P(−1, y); x, y=−1, 0, . . . , 7 are “unavailable”, the predicted pixel values Pred(x, y) of pixels in current macroblock A are generated as in Expression (25) below.

$$\begin{matrix}[ Eq . 10 ] & \\ Pred ( x , y ) = [ ( {\sum }_{n = 0}^{7} P ( n , - 1 ) ) + 4 ] >> 3 \\ with \\ x , y = 0 , … , 7 & ( 25 )\end{matrix}$$

Also, when P(x, −1); x, y=−1, 0, . . . , 7 are “unavailable”, the predicted pixel values Pred(x, y) of pixels in current macroblock A are generated as in Expression (26) below.

$$\begin{matrix}[ Eq . 11 ] & \\ Pred ( x , y ) = [ ( {\sum }_{n = 0}^{7} P ( - 1 , n ) ) + 4 ] >> 3 \\ with \\ x , y = 0 , … , 7 & ( 26 )\end{matrix}$$

Mode 1 is Horizontal Prediction, which is applied only when P(−1, y); x, y=−1, 0, . . . , 7 are “available”. In this case, the predicted pixel values Pred(x, y) of pixels in current macroblock A are generated as in Expression (27) below.

Pred(x, y)=P(−1, y); x, y=0, . . . , 7 (27)

Mode 2 is Vertical Prediction, which is applied only when P(x, −1); x, y=−1, 0, . . . , 7 are “available”. In this case, the predicted pixel values Pred(x, y) of pixels in current macroblock A are generated as in Expression (28) below.

Pred(x, y)=P(x, −1); x, y=0, . . . , 7 (28)

Mode 3 is Plane Prediction, which is applied when P(x, −1) and P(−1, y); x, y=−1, 0, . . . , 7 are “available”. In this case, the predicted pixel values Pred(x, y) of pixels in current macroblock A are generated as in Expression (29) below.

$$\begin{matrix}[ Eq . 12 ] & \\ Pred ( x , y ) = Clip 1 ( a + b \cdot ( x - 3 ) + c \cdot ( y - 3 ) + 16 ) >> 5 ; \\ x , y = 0 , … , 7 \\ a = 16 \cdot ( P ( - 1 , 7 ) + P ( 7 , - 1 ) ) \\ b = ( 17 \cdot H + 16 ) >> 5 \\ c = ( 17 \cdot V + 16 ) >> 5 \\ H = {\sum }_{x = 1}^{4} x \cdot [ P ( 3 + x , - 1 ) - P ( 3 - x , - 1 ) ] \\ V = {\sum }_{y = 1}^{4} y \cdot [ P ( - 1 , 3 + y ) - P ( - 1 , 3 - y ) ] & ( 29 )\end{matrix}$$

As described above, as intra-prediction modes for luminance signals, there are 9 kinds of prediction modes in 4×4 pixel and 8×8 pixel block units, and 4 kinds of prediction modes in 16×16 pixel block units, and as intra-prediction modes for chrominance signals, there are 4 kinds of intra-prediction modes in 8×8 pixel block units. The intra-prediction modes for chrominance signals can be set independently from the intra-prediction modes for luminance signals. As for the intra-prediction modes of 4×4 pixels and 8×8 pixels for luminance signals, one intra-prediction mode is defined for each of blocks of luminance signals of 4×4 pixels and 8×8 pixels. As for the intra-prediction modes of 16×16 pixels for luminance signals and the intra-prediction modes for chrominance signals, one prediction mode is defined for each single macroblock.

It should be noted that the kinds of prediction modes correspond to the directions indicated by the numbers 0, 1, and 3 to 8 in FIG. 9 described above. Prediction Mode 2 is mean prediction.

Next, the intra-prediction process in step S31 in FIG. 5, which is performed for each of these prediction modes, will be described with reference to the flowchart in FIG. 16. It should be noted that in the example in FIG. 16, the description is directed to the case of luminance signals.

In step S41, the intra-prediction unit 74 performs intra-prediction for each of the intra-prediction modes of 4×4 pixels, 8×8 pixels, and 16×16 pixels for luminance signals described above.

For example, the case of intra-prediction modes of 4×4 pixels will be described with reference to FIG. 10 described above. If an image to be processed (for example, pixels a to p) read from the screen rearrangement buffer 62 is an image of a block to be intra-processed, previously decoded images to be referenced (pixels whose pixels values A to M are shown) are read from the frame memory 72, and supplied to the intra-prediction unit 74 via the switch 73.

On the basis of these images, the intra-prediction unit 74 intra-predicts the pixels of the block to be processed. As this intra-prediction process is performed in each of intra-prediction modes, a predicted image in each of the intra-prediction modes is generated. It should be noted that as previously decoded pixels to be referenced (pixels whose pixels values A to M are shown), pixels prior to deblock filtering by the deblock filter 71 are used.

In step S42, the intra-prediction unit 74 computes a cost function value for each of the intra-prediction modes of 4×4 pixels, 8×8 pixels, and 16×16 pixels. Here, the computation of a cost function value is performed on the basis of a technique of either High Complexity mode or Low Complexity mode, as defined in JM (Joint Model) that is the reference software in H.264/AVC format.

That is, in High Complexity mode, as the process in step S41, processing up to an encoding process is provisionally performed for all the candidate prediction modes, and a cost function value represented by Expression (30) below is computed for each of the prediction modes, and the prediction mode that gives its minimum value is selected as the optimal prediction mode.

Cost(Mode)=D+λ·R (30)

D is the difference (distortion) between the original image and the decoded image, R is the size of generated code including orthogonal transform coefficients, and λ is a Lagrange multiplier given as a function of quantization parameter QP.

On the other hand, in Low Complexity mode, as the process in step S41, generation of a predicted image, and computation up to the header bit for motion vector information, prediction mode information, or the like are performed for all the candidate prediction modes, a cost function value represented by Expression (31) below is computed for each of the prediction modes, and the prediction mode that gives its minimum value is selected as the optimal prediction mode.

Cost(Mode)=D+QPtoQuant(QP)·Header_Bit (31)

D is the difference (distortion) between the original image and the decoded image, Header_Bit is the header bit for the prediction mode, and QPtoQuant is a function given as a function of quantization parameter QP.

In Low Complexity mode, only generation of a predicted image is performed for all the candidate prediction modes, and it is unnecessary to perform an encoding process and a decoding process, so computational complexity can be made small.

In step S43, the intra-prediction unit 74 determines the optimal modes for the respective intra-prediction modes of 4×4 pixels, 8×8 pixels, and 16×16 pixels. That is, as described above with reference to FIG. 9, in the case of intra-4×4 prediction modes and intra-8×8 prediction modes, there are 9 kinds of prediction modes, and in the case of intra-16×16 prediction modes, there are 4 kinds of prediction modes. Therefore, on the basis of the cost function values computed in step S42, the intra-prediction unit 74 determines the optimal intra-4×4 prediction mode, the optimal intra-8×8 prediction mode, and the optimal intra-16×16 prediction mode from among those modes.

In step S44, the intra-prediction unit 74 selects one intra-prediction mode on the basis of the cost function values computed in step S42, from among the respective optimal modes determined for the intra-prediction modes of 4×4 pixels, 8×8 pixels, and 16×16 pixels. That is, from among the respective optimal modes determined for 4×4 pixels, 8×8 pixels, and 16×16 pixels, the intra-prediction mode with the minimum cost function value is selected.

Next, referring to the flowchart in FIG. 17, the inter-motion prediction process in step S32 in FIG. 5 will be described.

In step S51, the motion prediction/compensation unit 77 determines a motion vector and a reference image for each of the 8 kinds of inter-prediction modes of 16×16 pixels to 4×4 pixels described above with reference to FIG. 2. That is, a motion vector and a reference image are determined for the block to be processed in each of the inter-prediction modes.

In step S52, the motion prediction/compensation unit 77 performs a motion prediction and compensation process on the reference image on the basis of the motion vector determined in step S51, with respect to each of the 8 kinds of inter-prediction modes of 16×16 pixels to 4×4 pixels. Through this motion prediction and compensation process, a predicted image in each of the inter-prediction modes is generated.

In step S53, the motion prediction/compensation unit 77 generates motion vector information to be attached to the compressed image, with respect to the motion vector determined for each of the 8 kinds of inter-prediction modes of 16×16 pixels to 4×4 pixels.

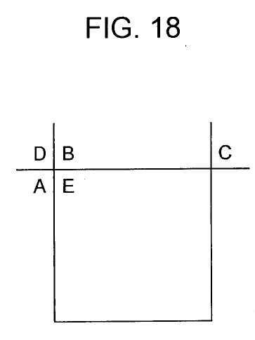

Here, referring to FIG. 18, a method of generating motion vector information in H.264/AVC format will be described. In the example in FIG. 18, current block E (for example, 16×16 pixels) to be encoded from now on, and blocks A to D that have been previously encoded and are adjacent to current block E are shown.

That is, block D is adjacent to the upper left of current block E, block B is adjacent above current block E, block C is adjacent to the upper right of current block E, and block A is adjacent to the left of current block E. It should be noted that the fact that blocks A to D are not divided up indicates that each block is a block of one of the configurations of 16×16 pixels to 4×4 pixels described above in FIG. 2.

For example, let mv_{X} represent motion vector information for X (=A, B, C, D, E). First, predicted motion vector information (predicted value of a motion vector) pmv_{E} for current block E is generated by median prediction as in Expression (32) below, by using motion vector information on blocks A, B, and C.

pmv_{E}=med(mv_{A}, mv_{B}, mv_{c}) (32)

If motion vector information on block C is unavailable for reasons such as the block being at the edge of a picture frame or not having been encoded yet, motion vector information on block C is substituted by motion vector information on block D.

Data mvd_{E} to be attached to the header part of the compressed image as motion vector information for current block E is generated as in Expression (33) below, by using pmv_{E}.

mvd_{E}=mv_{E}−pmv_{E} (33)

It should be noted that in actuality, processing is performed independently for each of the components in the horizontal direction and vertical direction of motion vector information.

By generating predicted motion vector information in this way, and attaching the difference between the predicted motion vector information generated by correlation with adjacent blocks, and motion vector information to the header part of the compressed image, the motion vector information can be reduced.

The motion vector information generated as described above is also used when computing cost function values in the next step S54, and when the corresponding predicted image is finally selected by the predicted image selecting unit 80, the motion vector information is outputted to the reversible encoding unit 66 together with mode information and reference frame information.

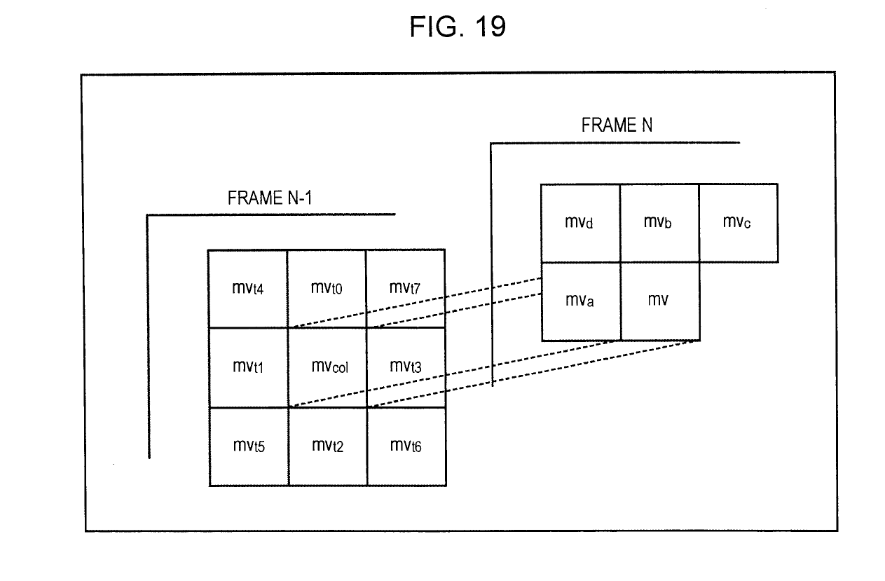

Also, another method of generating predicted motion vector information will be described with reference to FIG. 19. In the example in FIG. 19, frame N as a current frame to be encoded, and frame N-1 as a reference frame to be referenced when calculating a motion vector are shown.

In frame N, for a current block to be encoded from now on, motion vector information my for the current block is shown, and for each of blocks which has been previously encoded and is adjacent to the current block, motion vector information mvₐ, mv_{b}, mv_{c}, mv_{d} for each block is shown.

Specifically, for the block adjacent to the upper left of the current block, motion vector information mv_{d} for that block is shown, and for the block adjacent above the current block, motion vector information mv_{b} for that block is shown. For the block adjacent to the upper right of the current block, motion vector information mv_{c} for that block is shown, and for the block adjacent to the left of the current block, motion vector information mvₐ for that block is shown.

In frame N-1, for the co-located block of the current block, motion vector information mv_{col} for the co-located block is shown. Here, a co-located block is a block in a previously encoded frame (frame located before or after) different from the current frame and is co-located with the current block.

Also, for each of blocks adjacent to the co-located block in frame N-1, motion vector information mvₜ₄, mvₜ₀, mvₜ₇, mvₜ₁, mvₜ₃, mvₜ₅, mvₜ₂, mvₜ₆ for each block is shown.

Specifically, for the block adjacent to the upper left of the co-located block, motion vector information mvₜ₄ for that block is shown, and for the block adjacent above the co-located block, motion vector information mvₜ₀ for that block is shown. For the block adjacent to the upper right of the co-located block, motion vector information mvₜ₇ for that block is shown, and for the block adjacent to the left of the co-located block, motion vector information mvₜ₁ for that block is shown. For the block adjacent to the right of the co-located block, motion vector information mvₜ₃ for that block is shown, and for the block adjacent to the lower left of the co-located block, motion vector information mvₜ₅ for that block is shown. For the block adjacent below the co-located block, motion vector information mvₜ₂ for that block is shown, and for the block adjacent to the lower right of the co-located block, motion vector information mvₜ₆ for that block is shown.

While the predicted motion vector information pmv in Expression (32) described above is generated by motion vector information on blocks adjacent to the current block, predicted motion vector information pmvₜₘ₅, pmvₜₘ₉, pmv_{col} can be also generated as indicated in Expression (34) below.

pmvₜₘ₅=med(mv_{col}, mvₜ₀, . . . , mvₜ₃)

pmvₜₘ₉=med(mv_{col}, mvₜ₀, . . . , mvₜ₇)

pmv_{col}=med(mv_{col}, mv_{col}, mvₐ, mv_{b}, mv_{c}) (34)

Which predicted motion vector information to use out of Expression (32) and Expression (34) is selected by R-D optimization. Here, R is the size of generated code including orthogonal transform coefficients, and D is the difference (distortion) between the original image and the decoded image. That is, the predicted motion vector information that most optimizes the size of generated code and the difference between the original image and the decoded image is selected.

A format which generates a plurality of pieces of predicted motion vector information, and selects the optimal one from among those in this way will hereinafter be also referred to as MV Competition format.

Returning to FIG. 17, in step S54, the motion prediction/compensation unit 77 computes the cost function value represented by Expression (30) or Expression (31) described above, for each of the 8 kinds of inter-prediction modes of 16×16 pixels to 4×4 pixels. The cost function values computed here are used when determining the optimal inter-prediction mode in step S36 in FIG. 5 described above.

It should be noted that the computation of cost function values for inter-prediction modes also includes evaluation of cost function values of Skip Mode and Direct Mode defined in H.264/AVC format.

Next, referring to the flowchart in FIG. 20, the intra-template motion prediction process in step S33 in FIG. 5 will be described.

In step S61, the intra-predicted motion vector generating unit 76 generates predicted motion vector information for the current block, by using intra-motion vector information on blocks adjacent to the current block, which is stored in the built-in memory of the intra-TP motion prediction/compensation unit 75.

That is, the intra-predicted motion vector generating unit 76 generates predicted motion vector information pmv_{E} for current block E by using Expression (32), as described above with reference to FIG. 18.

In step S62, the intra-TP motion prediction/compensation unit 75 performs a motion prediction/compensation process in intra-template prediction mode. That is, the intra-TP motion prediction/compensation unit 75 calculates an intra-motion vector on the basis of the intra-template matching format, and generates a predicted image on the basis of the motion vector. At that time, the intra-motion vector search is performed within a search range centered on the predicted motion vector information generated by the intra-predicted motion vector generating unit 76.

The calculated intra-motion vector information is stored into the built-in memory (not shown) of the intra-TP motion prediction/compensation unit 75.

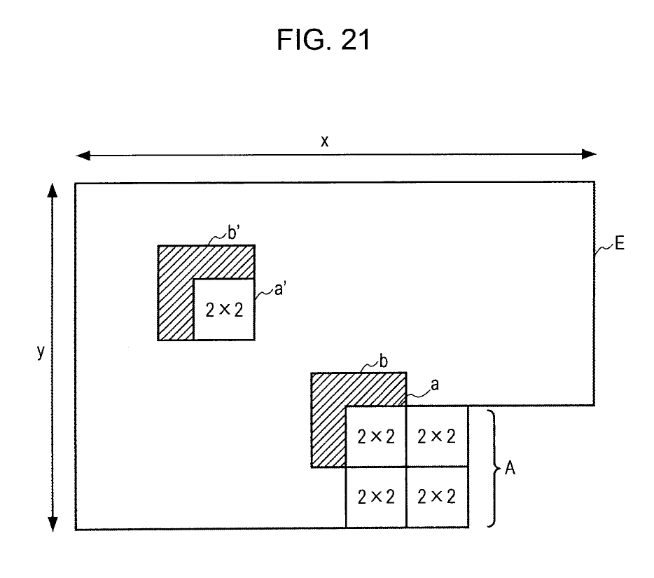

Here, the intra-template matching format will be described specifically with reference to FIG. 21.

In the example in FIG. 21, on an unillustrated current frame to be encoded, block A of 4×4 pixels, and predetermined search range E including only previously encoded pixels out of a region made up of X×Y (=vertical×horizontal) pixels are shown.

In block A, current sub-block a to be encoded from now on is shown. This current sub-block a is the sub-block located at the upper left, among the sub-blocks of 2×2 pixels constituting block A. Template region b including previously encoded pixels is adjacent to current block a. That is, template region b is a region which is located to the left of and above current sub-block a as shown in FIG. 21 when performing an encoding process in raster scan order, and is a region for which decoded images are accumulated in the frame memory 72.

The intra-TP motion prediction/compensation unit 75 performs a template matching process by using, for example, SAD (Sum of Absolute Difference) or the like as a cost function value, within predetermined search range E on the current frame, and finds region b′ with the highest correlation with the pixel values of template region b. Then, the intra-TP motion prediction/compensation unit 75 calculates a motion vector for current block a, by using block a′ corresponding to the found block b′ as a predicted image for current sub-block a.

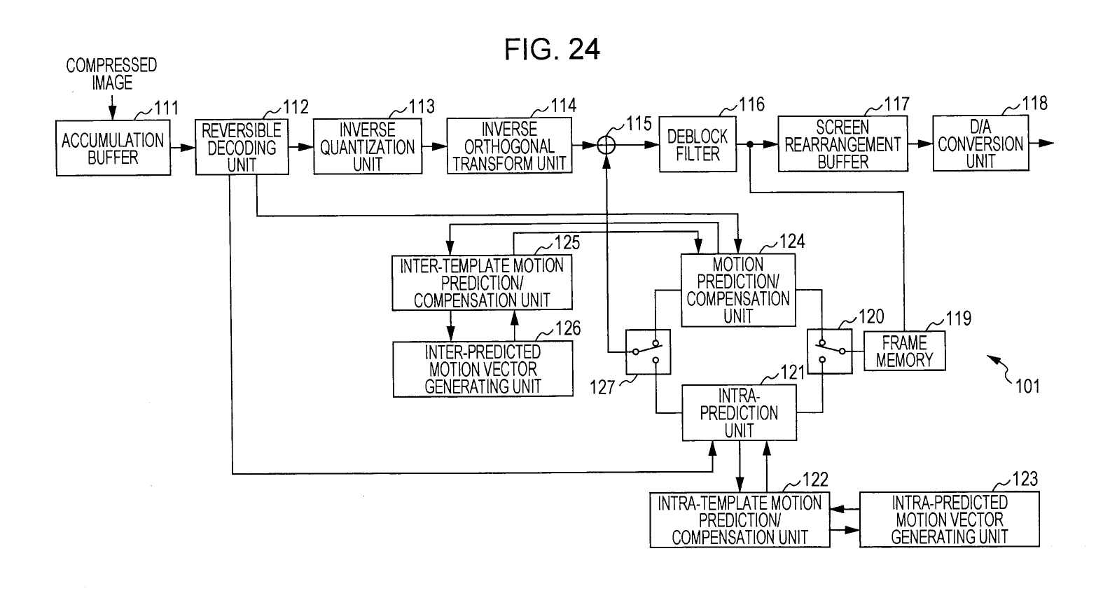

In this way, since the motion vector search process in intra-template matching format uses decoded images for the template matching process, by setting predetermined search range E in advance, it is possible to perform the same processing in the image encoding apparatus 51 in FIG. 1 and an image decoding apparatus 101 in FIG. 24 described later. That is, by constructing an inter-TP motion prediction/compensation unit 122 also in the image decoding apparatus 101, there is no need to send motion vector information for the current sub-block to the image decoding apparatus 101, thereby making it possible to reduce motion vector information in the compressed image.

Also, this predetermined search range E is a search range centered on predicted motion vector information generated by the intra-predicted motion vector generating unit 76. The predicted motion vector information generated by the intra-predicted motion vector generating unit 76 is generated by correlation with adjacent blocks, as described above with reference to FIG. 18.

Therefore, in the image decoding apparatus 101 as well, by constructing an intra-predicted motion vector generating unit 123, obtaining predicted motion vector information by correlation with the adjacent blocks, and calculating a motion vector within predetermined search range E centered on the predicted motion vector information, the search range can be limited without deteriorating encoding efficiency. That is, a decrease in compression efficiency can be prevented without increasing computational complexity.

It should be noted that in FIG. 21, while the description is directed to the case where the current sub-block is 2×2 pixels, this should not be construed restrictively, and application to sub-blocks of arbitrary sizes is possible. The block and template sizes in intra-template prediction mode are arbitrary. That is, in the same manner as in the intra-prediction unit 74, the intra-template prediction mode can be performed either by using the block sizes of individual intra-prediction modes as candidates, or by fixing the block size to that of one prediction mode. The template size may be made variable or can be fixed, in accordance with the current block size.

In step S63, the intra-TP motion prediction/compensation unit 75 computes the cost function value represented by Expression (30) or Expression (31) described above, for intra-template prediction mode. The cost function value computed here is used when determining the optimal intra-prediction mode in step S34 in FIG. 5 described above.

Here, in step S61 in FIG. 20, the description is directed to the case where intra-motion vector information is calculated with respect to every current block, and stored into the built-in memory. However, a processing method is also conceivable in which, for a block to be processed in one prediction mode out of intra-prediction mode, intra-template processing mode, inter-processing mode, and inter-template processing mode, predictions in the other prediction modes are not performed. In this processing method, adjacent blocks do not necessarily hold intra-motion vector information.

Hereinbelow, this processing method will be described while differentiating between the case when the current block is included in a frame to be intra-processed and the case when the current block is included in a frame to be inter-processed.

First, a description will be given of the case when the current block is included in a frame to be intra-processed. In this case, there are cases when adjacent blocks are blocks to be processed in intra-prediction mode, and when adjacent blocks are blocks to be processed in intra-template prediction mode. In the former case when the adjacent blocks are blocks to be processed in intra-template prediction mode, intra-motion vector information on the adjacent blocks exists.

However, in the latter case when the adjacent blocks are blocks to be processed in inter-prediction mode, intra-motion vector information on the adjacent blocks does not exist. Accordingly, as for the processing method in this case, there are a first method of performing median prediction with intra-motion vector information on the adjacent blocks taken as (0, 0), and a second method of generating intra-motion vector information on the adjacent blocks as well.

Next, a description will be given of the case when the current block is included in a frame to be inter-processed. In this case, there are cases when adjacent blocks are blocks to be intra-processed, and when adjacent blocks are blocks to be inter-processed. As for the former case when the adjacent blocks are blocks to be intra-processed, the method conforms to the above-described method in the case when the current block is included in a frame to be intra-processed.

In the latter case when the adjacent blocks are blocks to be inter-processed, cases are conceivable in which the blocks are blocks subject to inter-motion prediction mode, or blocks subject to inter-template motion prediction mode. In either case, the blocks have inter-motion vector information.

Accordingly, as for the processing method in this case, there are a first method of performing median prediction with intra-motion vector information on the adjacent blocks taken as (0, 0), a second method of generating intra-motion vector information on the adjacent blocks as well, and a third method of performing median prediction by using inter-motion vector information for the adjacent blocks, instead of intra-motion vector information for the adjacent blocks. It should be noted that with respect to the third method, at the time of processing, it is also possible to reference ref_id that is reference frame information, and perform median prediction by using inter-motion vector information only in the case when ref_id falls within a predetermined size, and by a method conforming to the first or second method in other cases (that is, when ref_id is larger than (farther way) than a predetermined value).

As described above, when performing motion prediction in intra-template prediction mode, prior to a search, a predicted value of a motion vector is generated, and a search process is performed centered on the predicted value of the motion vector. Thus, deterioration of encoding efficiency can be prevented even when the search range is limited. Also, by limiting the search range, computational complexity is also reduced.

Next, referring to the flowchart in FIG. 22, the inter-template motion prediction process in step S35 in FIG. 5 will be described.

In step S71, the inter-predicted motion vector generating unit 79 generates predicted motion vector information for a current block, by using inter-motion vector information on previously encoded blocks, which is stored in the built-in memory of the inter-TP motion prediction/compensation unit 78.

Specifically, the inter-predicted motion vector generating unit 79 generates predicted motion vector information pmv_{E} for current block E by using Expression (32), as described above with reference to FIG. 18. Alternatively, the inter-predicted motion vector generating unit 79 generates pieces of predicted motion vector information by using Expression (32) and Expression (34), as described above with reference to FIG. 19, and selects the optimal predicted motion vector information from those pieces of information.

It should be noted that in the case when adjacent blocks adjacent to the current block are blocks to be inter-predicted, inter-motion vector information calculated by inter-template prediction in step S72 described later may be used, or inter-motion vector information calculated by the inter-prediction in step S51 in FIG. 17 described above may be stored, and used.

Also, there is a possibility that adjacent blocks adjacent to the current block are blocks to be intra-predicted or blocks to be intra-template predicted. In either case, the inter-predicted motion vector generating unit 79 generates predicted motion vector information by performing median prediction with inter-motion vector information for adjacent blocks taken as (0, 0). Alternatively, the inter-predicted motion vector generating unit 79 can also perform motion search in inter-template matching format for the adjacent blocks that are blocks to be intra-predicted or blocks to be intra-template predicted, and perform median prediction by using the calculated inter-motion vector information.

Further, in the case when the adjacent blocks are blocks to be intra-template predicted, the inter-predicted motion vector generating unit 79 can also generate predicted motion vector information by performing median prediction using intra-motion vector information, instead of inter-motion vector information.

In step S72, the inter-TP motion prediction/compensation unit 78 performs a motion prediction/compensation process in inter-template prediction mode. That is, the inter-TP motion prediction/compensation unit 78 calculates an inter-motion vector on the basis of the inter-template matching format, and generates a predicted image on the basis of the motion vector. At that time, the search for an intra-motion vector is performed within a search range centered on the predicted motion vector information generated by the inter-predicted motion vector generating unit 79.

The calculated inter-motion vector information is stored into the built-in memory (not shown) of the inter-TP motion prediction/compensation unit 78.

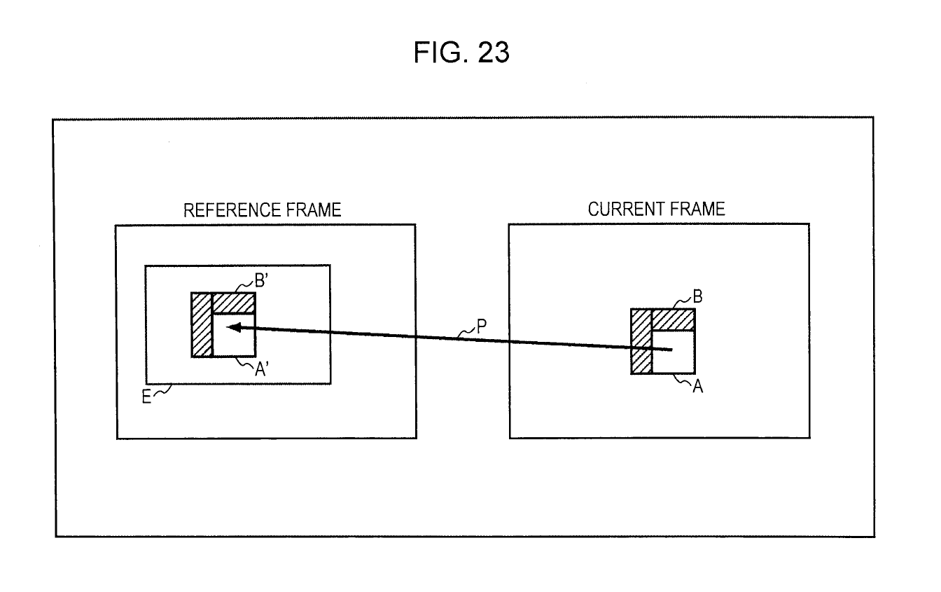

Here, the inter-template matching format will be specifically described with reference to FIG. 23.

In the example in FIG. 23, a current frame to be encoded, and a reference frame to be referenced when calculating a motion vector are shown. In the current frame, current block A to be encoded from now on, and template region B adjacent to current block A and made up of previously encoded pixels are shown. That is, in the case of performing an encoding process in raster scan order, as shown in FIG. 23, template region B is a region located to the left of and above current block A, and is a region for which decoded images are accumulated in the frame memory 72.

The inter-TP motion prediction/compensation unit 78 performs a template matching process by using, for example, SAD (Sum of Absolute Difference) or the like as a cost function value, within predetermined search range E on the reference frame, and finds region B′ with the highest correlation with the pixel values of template region B. Then, the inter-TP motion prediction/compensation unit 78 calculates motion vector P for current block A, by using block A′ corresponding to the found region B′ as a predicted image for current block A.

In this way, since the motion vector search process in inter-template matching format uses decoded images for the template matching process, by setting predetermined search range E in advance, it is possible to perform the same processing in the image encoding apparatus 51 in FIG. 1 and the image decoding apparatus 101 in FIG. 24 described later. That is, by constructing an inter-TP motion prediction/compensation unit 125 also in the image decoding apparatus 101, there is no need to send information on motion vector P for current sub-block A to the image decoding apparatus 101, thereby making it possible to reduce motion vector information in the compressed image.

Also, this predetermined search range E is a search range centered on predicted motion vector information generated by the inter-predicted motion vector generating unit 79. The predicted motion vector information generated by the inter-predicted motion vector generating unit 79 is generated by correlation with adjacent blocks, as described above with reference to FIG. 18.

Therefore, in the image decoding apparatus 101 as well, by constructing an inter-predicted motion vector generating unit 126, obtaining predicted motion vector information by correlation with the adjacent blocks, and calculating a motion vector within predetermined search range E centered on the predicted motion vector information, the search range can be limited without deteriorating encoding efficiency. That is, a decrease in compression efficiency can be prevented without increasing computational complexity.

It should be noted that the block and template sizes in inter-template prediction mode are arbitrary. That is, in the same manner as in the motion prediction/compensation unit 77, the inter-template prediction mode can be performed either by fixing one block size from among the 8 kinds of block sizes of 16×16 pixels to 8×8 pixels described above in FIG. 2, or with all the block sizes as candidates. The template size may be made variable or can be fixed, in accordance with the block size.

In step S73, the inter-TP motion prediction/compensation unit 78 computes the cost function value represented by Expression (30) or Expression (31) described above, for inter-template prediction mode. The cost function value computed here is used when determining the optimal inter-prediction mode in step S36 in FIG. 5 described above.

As described above, when performing motion prediction in inter-template prediction mode as well, prior to a search, a predicted value of a motion vector is generated, and a search process is performed centered on the predicted value of the motion vector. Thus, deterioration of encoding efficiency can be prevented even when the search range is limited. Also, by limiting the search range, computational complexity is also reduced.

The encoded compressed image is transmitted via a predetermined transmission path, and decoded by an image decoding apparatus. FIG. 24 shows the configuration of an embodiment of such an image decoding apparatus.

The image decoding apparatus 101 includes an accumulation buffer 111, a reversible decoding unit 112, an inverse quantization unit 113, an inverse orthogonal transform unit 114, a computing unit 115, a deblock filter 116, a screen rearrangement buffer 117, a D/A conversion unit 118, a frame memory 119, a switch 120, an intra-prediction unit 121, the intra-template motion prediction/compensation unit 122, the intra-predicted motion vector generating unit 123, a motion prediction/compensation unit 124, the inter-template motion prediction/compensation unit 125, the inter-predicted motion vector generating unit 126, and a switch 127.

It should be noted that hereinafter, the intra-template motion prediction/compensation unit 122 and the inter-template motion prediction/compensation unit 125 will be referred to as intra-TP motion prediction/compensation unit 122 and inter-TP motion prediction/compensation unit 125, respectively.

The accumulation buffer 111 accumulates compressed images transmitted thereto. The reversible decoding unit 112 decodes information encoded by the reversible encoding unit 66 in FIG. 1 and supplied from the accumulation buffer 111, in a format corresponding to the encoding format of the reversible encoding unit 66. The inverse quantization unit 113 performs inverse quantization on the image decoded by the reversible decoding unit 112, in a format corresponding to the quantization format of the quantization unit 65 in FIG. 1. The inverse orthogonal transform unit 114 performs an inverse orthogonal transform on the output of the inverse quantization unit 113 in a format corresponding to the orthogonal transform format of the orthogonal transform unit 64 in FIG. 1.

The inverse orthogonal transformed output is summed with a predicted image supplied from the switch 127 and decoded. After removing block distortions in the decoded image, the deblock filter 116 supplies the resulting image to the frame memory 119 for accumulation, and also outputs the resulting image to the screen rearrangement buffer 117.

The screen rearrangement buffer 117 performs rearrangement of images. That is, the order of frames rearranged for the order of encoding by the screen rearrangement buffer 62 in FIG. 1 is rearranged to the original display order. The D/A conversion unit 118 performs D/A conversion on an image supplied from the screen rearrangement buffer 117, and outputs the resulting image to an unillustrated display for display thereon.

The switch 120 reads from the frame memory 119 an image to be inter-encoded and images to be referenced, and outputs the images to the motion prediction/compensation unit 124, and also reads images used for intra-prediction, and outputs the images to the intra-prediction unit 121.

Information on intra-prediction mode obtained by decoding header information is supplied to the intra-prediction unit 121 from the reversible decoding unit 112. If information indicating intra-prediction mode is supplied, the intra-prediction unit 121 generates a predicted image on the basis of this information. If information indicating intra-template prediction mode is supplied, the intra-prediction unit 121 supplies images used for intra-prediction to the intra-TP motion prediction/compensation unit 122, and causes a motion prediction/compensation process to be performed in intra-template prediction mode.

The intra-prediction unit 121 outputs the generated predicted image or a predicted image generated by the intra-TP motion prediction/compensation unit 122, to the switch 127.

The intra-TP motion prediction/compensation unit 122 performs the same motion prediction and compensation process in intra-template prediction mode as that in the intra-TP motion prediction/compensation unit 75 in FIG. 1. That is, the intra-TP motion prediction/compensation unit 122 generates a predicted image by performing a motion prediction and compensation process in intra-template prediction mode, on the basis of the images used for intra-prediction read from the frame memory 119. At that time, the intra-TP motion prediction/compensation unit 122 performs motion prediction within a predetermined search range centered on predicted motion vector information generated by the intra-predicted motion vector generating unit 123.

The predicted image generated by motion prediction/compensation in intra-template prediction mode is supplied to the intra-prediction unit 121. Also, intra-motion vector information calculated by motion prediction in intra-template prediction mode is stored into the built-in buffer (not shown) of the intra-TP motion prediction/compensation unit 122.

The intra-predicted motion vector generating unit 123 generates predicted motion vector information, in the same manner as in the intra-predicted motion vector generating unit 76 in FIG. 1. That is, predicted motion vector information for the current block is generated by using motion vector information on previously encoded blocks, which is stored in the built-in memory of the intra-TP motion prediction/compensation unit 122. For the generation of predicted motion vector information, for example, motion vector information on blocks adjacent to the current block is used.

Information obtained by decoding header information (prediction mode, motion vector information, and reference frame information) is supplied to the motion prediction/compensation unit 124 from the reversible decoding unit 112. If information indicating inter-prediction mode is supplied, the motion prediction/compensation unit 124 generates a predicted image by applying a motion prediction and compensation process to an image on the basis of motion vector information and reference frame information. If information indicating inter-prediction mode is supplied, the motion prediction/compensation unit 124 supplies an image to be inter-encoded and images to be referenced which are read from the frame memory 119, to the inter-TP motion prediction/compensation unit 125, and causes a motion prediction/compensation process to be performed in inter-template prediction mode.

Also, in accordance with prediction mode information, the motion prediction/compensation unit 124 outputs either the predicted image generated in inter-prediction mode, or the predicted image generated in inter-template prediction mode, to the switch 127.

The inter-TP motion prediction/compensation unit 125 performs the same motion prediction and compensation process in inter-template prediction mode as that in the inter-TP motion prediction/compensation unit 78 in FIG. 1. That is, the inter-TP motion prediction/compensation unit 125 generates a predicted image by performing a motion prediction and compensation process in inter-template prediction mode, on the basis of the image to be inter-encoded and the images to be referenced which are read from the frame memory 119. At that time, the inter-TP motion prediction/compensation unit 125 performs motion prediction within a predetermined search range centered on predicted motion vector information generated by the inter-predicted motion vector generating unit 126.

The predicted image generated by motion prediction/compensation in inter-template prediction mode is supplied to the motion prediction/compensation unit 124. Inter-motion vector information calculated by motion prediction in inter-template prediction mode is stored into the built-in buffer (not shown) of the inter-TP motion prediction/compensation unit 125.

The inter-predicted motion vector generating unit 126 generates predicted motion vector information, in the same manner as in the inter-predicted motion vector generating unit 79 in FIG. 1. That is, predicted motion vector information for the current block is generated by using motion vector information on previously encoded blocks, which is stored in the built-in memory of the inter-TP motion prediction/compensation unit 125. For the generation of predicted motion vector information, for example, motion vector information on blocks adjacent to the current block, the co-located block described above with reference to FIG. 19, blocks adjacent to the co-located block, and the like is used.

The switch 127 selects a predicted image generated by the motion prediction/compensation unit 124 or the intra-prediction unit 121, and outputs the predicted image to the computing unit 115.

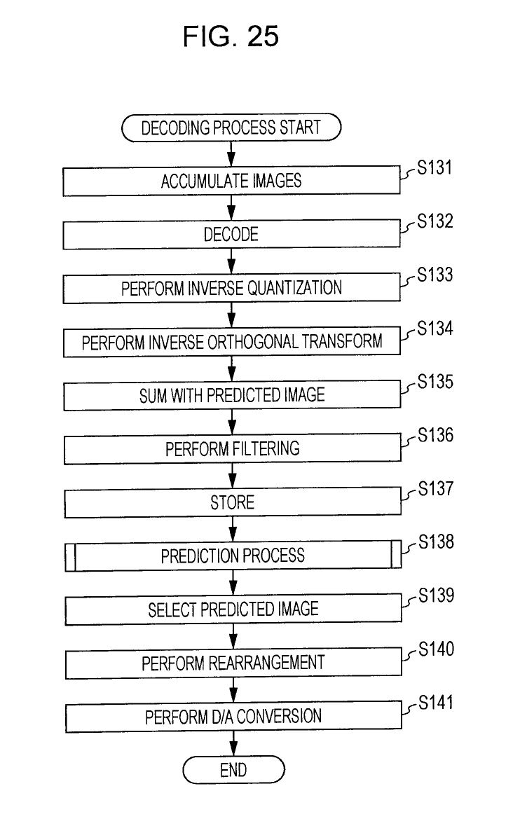

Next, referring to the flowchart in FIG. 25, a decoding process executed by the image decoding apparatus 101 will be described.

In step S131, the accumulation buffer 111 accumulates images transmitted thereto. In step S132, the reversible decoding unit 112 decodes compressed images supplied from the accumulation buffer 111. That is, the I-pictures, P-pictures, and B-pictures encoded by the reversible encoding unit 66 in FIG. 1 are decoded.

At this time, motion vector information and prediction mode information (information indicative of intra-prediction mode, intra-template prediction mode, inter-prediction mode, or inter-template prediction mode) are also decoded. That is, if the prediction mode information indicates intra-prediction mode or intra-template prediction mode, the prediction mode information is supplied to the intra-prediction unit 121. If the prediction mode information indicates inter-prediction mode or inter-template prediction mode, the prediction mode is supplied to the motion prediction/compensation unit 124. At that time, if there are corresponding motion vector information and reference frame information, those pieces of information are also supplied to the motion prediction/compensation unit 124.

In step S133, the inverse quantization unit 113 performs inverse quantization on transform coefficients decoded by the reversible decoding unit 112, in accordance with characteristics corresponding to the characteristics of the quantization unit 65 in FIG. 1. In step S134, the inverse orthogonal transform unit 114 performs an inverse orthogonal transform on the transform coefficients inverse quantized by the inverse quantization unit 113, in accordance with characteristics corresponding to the characteristics of the orthogonal transform unit 64 in FIG. 1. This means that difference information corresponding to the input of the orthogonal transform unit 64 (the output of the computing unit 63) in FIG. 1 has been decoded.

In step S135, the computing unit 115 sums a predicted image, which is selected in the process of step S139 described later and inputted via the switch 127, with the difference information. Thus, the original image is decoded. In step S136, the deblock filter 116 performs filtering on the image outputted by the computing unit 115. Thus, block distortions are removed. In step S137, the frame memory 119 stores the filtered image.

In step S138, the intra-prediction unit 121, the intra-TP motion prediction/compensation unit 122, the motion prediction/compensation unit 124, or the inter-TP motion prediction/compensation unit 125 performs an image prediction process, in correspondence with prediction mode information supplied from the reversible decoding unit 112.

That is, if intra-prediction mode information is supplied from the reversible decoding unit 112, the intra-prediction unit 121 performs an intra-prediction process in intra-prediction mode. If intra-template prediction mode information is supplied from the reversible decoding unit 112, the intra-TP motion prediction/compensation unit 122 performs a motion prediction/compensation process in intra-template prediction mode. Also, if inter-prediction mode information is supplied from the reversible decoding unit 112, the motion prediction/compensation unit 124 performs a motion prediction/compensation process in inter-template prediction mode. If inter-template prediction mode information is supplied from the reversible decoding unit 112, the inter-TP motion prediction/compensation unit 125 performs a motion prediction/compensation process in inter-template prediction mode.

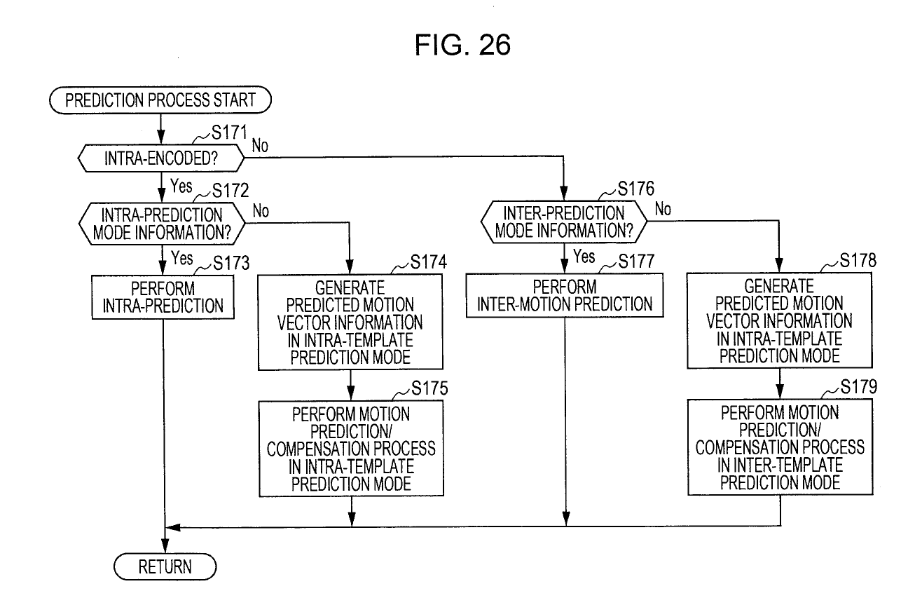

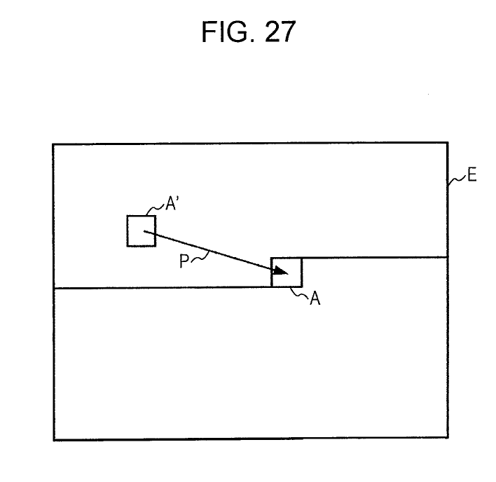

While details of the prediction process in step S138 will be described later with reference to FIG. 26, through this process, a predicted image generated by the intra-prediction unit 121, a predicted image generated by the intra-TP motion prediction/compensation unit 122, a predicted image generated by the motion prediction/compensation unit 124, or a predicted image generated by the inter-TP motion prediction/compensation unit 125 is supplied to the switch 127.

In step S139, the switch 127 selects a predicted image. That is, since a predicted image generated by the intra-prediction unit 121, a predicted image generated by the intra-TP motion prediction/compensation unit 122, a predicted image generated by the motion prediction/compensation unit 124, or a predicted image generated by the inter-TP motion prediction/compensation unit 125 is supplied, the supplied predicted image is selected and supplied to the computing unit 115, and as described above, is summed with the output of the inverse orthogonal transform unit 114 in step S134.

In step S140, the screen rearrangement buffer 117 performs rearrangement. That is, the order of frames rearranged for encoding by the screen rearrangement buffer 62 of the image encoding apparatus 51 is rearranged to the original display order.

In step S141, the D/A conversion unit 118 performs D/A conversion on an image from the screen rearrangement buffer 117. This image is outputted to an unillustrated display, and the image is displayed.

Next, referring to the flowchart in FIG. 26, the prediction process in step S138 in FIG. 25 will be described.

In step S171, the intra-prediction unit 121 judges whether or not the current block has been intra-encoded. When intra-prediction mode information or intra-template prediction mode information is supplied from the reversible decoding unit 112 to the intra-prediction unit 121, the intra-prediction unit 121 judges in step S171 that the current block has been intra-encoded, and in step S172, judges whether or not the prediction mode information from the reversible decoding unit 112 is intra-prediction mode information.

If it is judged in step S172 that the prediction mode information is intra-prediction mode information, in step S173, the intra-prediction unit 121 performs intra-prediction.

That is, if the image to be processed is an image to be intra-processed, necessary images are read from the frame memory 119, and supplied to the intra-prediction unit 121 via the switch 120. In step S173, the intra-prediction unit 121 performs intra-prediction in accordance with the intra-prediction mode information supplied from the reversible decoding unit 112, and generates a predicted image.

If it is judged in step S172 that the prediction mode information is not intra-prediction mode information, the processing proceeds to step S174, and processing in intra-template prediction mode is performed.

If the image to be processed is an image to be intra-template-prediction processed, necessary images are read from the frame memory 119, and supplied to the intra-TP motion prediction/compensation unit 122 via the switch 120 and the intra-prediction unit 121. In step S174, the intra-TP motion prediction/compensation unit 122 causes the intra-predicted motion vector generating unit 123 to generate predicted motion vector information for the current block, and in step S175, on the basis of the images read from the frame memory 119, an intra-template motion prediction process is performed in intra-template prediction mode.

That is, in step S174, the intra-predicted motion vector generating unit 123 generates predicted motion vector information for the current block, by using intra-motion vector information on blocks adjacent to the current block, which is stored in the built-in memory of the intra-TP motion prediction/compensation unit 122.

In step S175, the intra-TP motion prediction/compensation unit 122 calculates an intra-motion vector on the basis of the intra-template matching format, within a predetermined search range centered on the predicted motion vector information generated by the intra-predicted motion vector generating unit 123, and generates a predicted image on the basis of the motion vector. At this time, the calculated intra-motion vector information is stored into the built-in memory (not shown) of the intra-TP motion prediction/compensation unit 122.

It should be noted that as this processing in steps S174 and S175, basically the same processing as in steps S61 and S62 in FIG. 20 described above is performed, so detailed description thereof is omitted.

On the other hand, if it is judged in step S171 that the block has not been intra-encoded, the processing proceeds to step S176.

If the image to be processed is an image to be inter-processed, inter-prediction mode information, reference frame information, and motion vector information are supplied from the reversible decoding unit 112 to the motion prediction/compensation unit 124. In step S176, the motion prediction/compensation unit 124 judges whether or not the prediction mode information from the reversible decoding unit 112 is inter-prediction mode information, and if it is judged that the prediction mode information is inter-prediction mode information, performs inter-motion prediction in step S177.

If the image to be processed is an image to be inter-prediction processed, necessary images are read from the frame memory 119, and supplied to the motion prediction/compensation unit 124 via the switch 120. In step S177, the motion prediction/compensation unit 124 performs motion prediction in inter-prediction mode on the basis of the motion vector supplied from the reversible decoding unit 112, and generates a predicted image.

If it is judged in step S176 that the prediction mode information is not inter-prediction mode information, the processing proceeds to step S178, and processing in inter-template prediction mode is performed.

If the image to be processed is an image to be inter-template-prediction processed, necessary images are read from the frame memory 119, and supplied to the inter-TP motion prediction/compensation unit 125 via the switch 120 and the motion prediction/compensation unit 124. In step S178, the inter-TP motion prediction/compensation unit 125 causes the inter-predicted motion vector generating unit 126 to generate predicted motion vector information for the current block, and in step S179, on the basis of the images read from the frame memory 119, an inter-template motion prediction process is performed in inter-template prediction mode.

That is, in step S178, the inter-predicted motion vector generating unit 126 generates predicted motion vector information for the current block, by using inter-motion vector information on previously encoded blocks, which is stored in the built-in memory of the inter-TP motion prediction/compensation unit 125.

Specifically, the inter-predicted motion vector generating unit 126 generates predicted motion vector information pmv_{E} for current block E by using Expression (32), as described above with reference to FIG. 18. Alternatively, the inter-predicted motion vector generating unit 126 generates pieces of predicted motion vector information by using Expression (32) and Expression (34), as described above with reference to FIG. 19, and selects the optimal predicted motion vector information from those pieces of information.

In step S179, the inter-TP motion prediction/compensation unit 125 calculates an inter-motion vector on the basis of the inter-template matching format, within a predetermined search range centered on the predicted motion vector information generated by the inter-predicted motion vector generating unit 126, and generates a predicted image on the basis of the motion vector. At this time, the calculated inter-motion vector information is stored into the built-in memory (not shown) of the inter-TP motion prediction/compensation unit 125.

It should be noted that as this processing in steps S178 and S179, basically the same processing as in steps S71 and S72 in FIG. 22 described above is performed, so detailed description thereof is omitted.

As described above, in the image encoding apparatus and the image decoding apparatus, motion prediction based on template matching which performs motion search using decoded images is performed. Thus, good image quality can be displayed without sending motion vector information.

Also, at that time, predicted motion vector information is generated by correlation with adjacent blocks, and the search range centered thereon is limited. Thus, the computational complexity required for motion vector search can be reduced without causing a decrease in compression efficiency.

Further, when performing a motion prediction/compensation process in H.264/AVC format, a prediction based on template matching is also performed, and an encoding process is performed by selecting the one with the better cost function value. Thus, encoding efficiency can be improved.

It should be noted that the method of setting a predicted motion vector as the center of search as described above can be applied also to the intra-motion prediction/compensation as shown in FIG. 28. In the example in FIG. 28, in the image encoding apparatus, on the same frame, block A′ with the highest correlation with the pixel values of current block A to be encoded is found, and a motion vector is calculated. In the image decoding apparatus, the motion vector information calculated in the image encoding apparatus and decoded images are used to perform motion compensation.

At the time of this block search in the image encoding apparatus as well, intra-motion vector information is computed in advance by correlation with adjacent blocks, and search range E centered on the intra-motion vector information is used. In this case as well, an increase in the computational complexity required for the search can be prevented.

While the H.264/AVC format is used as the encoding format in the foregoing description, other encoding/decoding formats can be used as well.

It should be noted that the present invention can be applied to, for example, an image encoding apparatus and an image decoding apparatus which are used when receiving image information (bit stream) compressed by an orthogonal transform such as a discrete cosine transform and motion compensation, as in MPEG, H.26x, or the like, via network media such as a satellite broadcast, a cable TV (television), the Internet, and a mobile phone, or when processing the image information on recording media such as an optical/magnetic disc and a flash memory.

The series of processes described above can be either executed by hardware or executed by software. If the series of processes is to be executed by software, a program constituting the software is installed into a computer embedded in dedicated hardware, or into, for example, a general-purpose personal computer or the like that can execute various kinds of function when installed with various kinds of program, from a program-recording medium.

The program-recording medium for storing the program that is installed into the computer and can be executed by the computer is configured by removable media as packaged media such as a magnetic disc (including a flexible disc), an optical disc (including a CD-ROM (Compact Disc-Read Only Memory), a DVD (Digital Versatile Disc)), including a magneto-optical disc), or a semiconductor memory, or is configured by a ROM or hard disk on which the program is temporarily or permanently stored. Storage of the program onto the program-recording medium is performed by using a wired or wireless communication medium such as local area network, Internet, or digital satellite broadcast, via an interface such as a router or a modem as required.

It should be noted that in this specification, steps describing the program include not only processes that are executed in a time-series fashion in the order as described, but also processes that are not necessarily processed in a time-series fashion but executed in parallel or individually.

Also, embodiments of the present invention are not limited to the above-described embodiments, and various modifications are possible without departing from the scope of the present invention.

### REFERENCE SIGNS LIST

51 image encoding apparatus

66 reversible encoding unit

74 intra-prediction unit

75 intra-template motion prediction/compensation unit

76 intra-predicted motion vector generating unit

77 motion prediction/compensation unit

78 inter-template motion prediction/compensation unit

79 inter-predicted motion vector generating unit

80 predicted image selecting unit

112 reversible decoding unit

121 intra-prediction unit

122 intra-template motion prediction/compensation unit

123 intra-predicted motion vector generating unit

124 motion prediction/compensation unit

125 inter-template motion prediction/compensation unit

126 inter-predicted motion vector generating unit

127 switch

1. An image processing apparatus comprising:
a predicted motion vector generating unit that generates a predicted value of a motion vector of a first current block in a frame; and
a first motion prediction/compensation unit that calculates a motion vector of the first current block by using a first template, within a predetermined search range around the predicted value of the motion vector generated by the predicted motion vector generating unit, the first template being adjacent to the first current block in a predetermined positional relationship and generated from a decoded image.

2. The image processing apparatus according to claim 1, wherein the predicted motion vector generating unit generates the predicted value of the motion vector of the first current block by using information on motion vectors for adjacent blocks, the adjacent blocks being previously encoded blocks and blocks adjacent to the first current block.

3. The image processing apparatus according to claim 2, wherein the predicted motion vector generating unit generates the predicted value of the motion vector of the first current block by using the information on the motion vectors calculated for the adjacent blocks within the frame.

4. The image processing apparatus according to claim 3, wherein if the information on the motion vectors calculated for the adjacent blocks within the frame does not exist, the predicted motion vector generating unit generates the predicted value of the motion vector of the first current block by setting the information on the motion vectors for the adjacent blocks to 0.

5. The image processing apparatus according to claim 3, wherein if the information on the motion vectors calculated for the adjacent blocks within the frame does not exist, the predicted motion vector generating unit generates the predicted value of the motion vector of the first current block by using information on motion vectors calculated for the adjacent blocks by referencing a previously encoded frame different from the frame.

6. The image processing apparatus according to claim 5, wherein if information on the previously encoded frame is larger than a predetermined value, the predicted motion vector generating unit prohibits use of the information on the motion vectors calculated for the adjacent blocks by referencing the previously encoded frame.

7. The image processing apparatus according to claim 3, wherein:
if the information on the motion vectors calculated for the adjacent blocks within the frame does not exist, the first motion prediction/compensation unit calculates motion vectors of the adjacent blocks by using a second template, the second template being adjacent to each of the adjacent blocks in a predetermined positional relationship and generated from the decoded image; and
the predicted motion vector generating unit generates the predicted value of the motion vector of the first current block by using the information on the motion vectors for the adjacent blocks calculated by the first motion prediction/compensation unit.

8. The image processing apparatus according to claim 3, further comprising:
an intra-prediction unit that predicts pixel values of a second current block in the frame from the decoded image within the frame.

9. The image processing apparatus according to claim 2, wherein the predicted motion vector generating unit generates the predicted value of the motion vector of the first current block by using the information on the motion vectors calculated for the adjacent blocks by referencing a previously encoded frame different from the frame.

10. The image processing apparatus according to claim 9, wherein if the information on the motion vectors calculated for the adjacent blocks by referencing the previously encoded frame does not exist, the predicted motion vector generating unit generates the predicted value of the motion vector of the first current block by setting the information on the motion vectors for the adjacent blocks to 0.

11. The image processing apparatus according to claim 9, wherein if the information on the motion vectors calculated for the adjacent blocks by referencing the previously encoded frame does not exist, the predicted motion vector generating unit generates the predicted value of the motion vector of the first current block by using information on motion vectors calculated for the adjacent blocks within the frame.

12. The image processing apparatus according to claim 9, wherein:
wherein if the information on the motion vectors calculated for the adjacent blocks by referencing the previously encoded frame does not exist, the first motion prediction/compensation unit calculates motion vectors of the adjacent blocks by using a second template, the second template being adjacent to each of the adjacent blocks in a predetermined positional relationship and generated from the decoded image; and
the predicted motion vector generating unit generates the predicted value of the motion vector of the first current block by using the information on the motion vectors for the adjacent blocks calculated by the first motion prediction/compensation unit.

13. The image processing apparatus according to claim 9, further comprising:
a decoding unit that decodes encoded information on a motion vector; and
a second motion prediction/compensation unit that generates a predicted image by using a motion vector of a second current block in the frame decoded by the decoding unit.

14. The image processing apparatus according to claim 1, wherein the predicted motion vector generating unit generates the predicted value of the motion vector of the first current block by using information on motion vectors for adjacent blocks, the adjacent blocks being previously encoded blocks and blocks adjacent to the first current block, information on motion vectors for a co-located block and blocks adjacent to the co-located block, the co-located block being a block in a previously encoded frame different from the frame and a block co-located with the first current block, or information on motion vectors for the co-located block and the adjacent blocks.

15. The image processing apparatus according to claim 14, wherein if the information on the motion vectors calculated for the adjacent blocks by referencing the previously encoded frame does not exist, the predicted motion vector generating unit generates the predicted value of the motion vector of the first current block by setting the information on the motion vectors for the adjacent blocks to 0.

16. The image processing apparatus according to claim 14, wherein if the information on the motion vectors calculated for the adjacent blocks by referencing the previously encoded frame does not exist, the predicted motion vector generating unit generates the predicted value of the motion vector of the first current block by using information on motion vectors calculated for the adjacent blocks within the frame.

17. The image processing apparatus according to claim 14, wherein if the information on the motion vectors calculated for the adjacent blocks by referencing the previously encoded frame does not exist, the first motion prediction/compensation unit calculates motion vectors of the adjacent blocks by using a second template, the second template being adjacent to each of the adjacent blocks in a predetermined positional relationship and generated from the decoded image; and
the predicted motion vector generating unit generates the predicted value of the motion vector of the first current block by using the information on the motion vectors for the adjacent blocks calculated by the first motion prediction/compensation unit.

18. The image processing apparatus according to claim 14, further comprising:
a decoding unit that decodes encoded information on a motion vector; and
a second motion prediction/compensation unit that generates a predicted image by using a motion vector of a second current block in the frame decoded by the decoding unit.

19. An image processing method, comprising the steps of an image processing apparatus:
generating a predicted value of a motion vector of a current block in a frame; and
calculating a motion vector of the current block by using a template, within a predetermined search range around the generated predicted value of the motion vector, the template being adjacent to the current block in a predetermined positional relationship and generated from a decoded image.
